(19) United States
(12) Patent Application Publication
(10) Pub. No.: US 2020/0217542 A1
(43) Pub. Date: Jul. 9, 2020

(54) DIAGNOSTIC METHOD, DIAGNOSTIC APPARATUS, DIAGNOSTIC SYSTEM, AND NON-TRANSITORY COMPUTER READABLE RECORDING MEDIUM STORING DIAGNOSTIC PROGRAM

(71) Applicant: Panasonic Intellectual Property Management Co., Ltd., Osaka (JP)

(72) Inventors: Masao NONAKA, Osaka (JP); Yuji OSAKI, Osaka (JP)

(21) Appl. No.: 16/710,155

(22) Filed: Dec. 11, 2019

(30) Foreign Application Priority Data
Jan. 7, 2019 (JP) 2019-000567

(51) Int. Cl. F24F 11/38; F24F 11/49; F24F 11/52; G06F 11/34

(52) U.S. Cl. CPC F24F 11/38; G06F 11/3476; F24F 11/52; F24F 11/49

(57) ABSTRACT

A diagnostic apparatus determines, for an element in a diagnostic element table, whether log information stored in a log storing unit satisfies a predetermined condition, the element indicating that a failure symptom can be diagnosed provided that the log information satisfies the predetermined condition, changes, based on a result of the determination, the element in the diagnostic element table to indicate the failure symptom can be diagnosed or cannot be diagnosed, the element originally indicating that the failure symptom can be diagnosed provided that the log information satisfies a predetermined condition, calculates a diagnostic priority of a plurality of operating conditions based on the statistical information and the changed diagnostic element table, and outputs information based on an operating condition, among a plurality of operating conditions, having the diagnostic priority satisfying the predetermined condition.

### FIELD OF THE INVENTION

The present disclosure relates to a diagnostic method, a diagnostic apparatus, and a diagnostic system each for diagnosing a device, and a non-transitory computer readable recording medium storing a diagnostic program for diagnosing a device.

### BACKGROUND ART

Techniques to perform failure diagnosis using a log of an air conditioning device are disclosed, for example, in JP 2007-263442 A and JP 2004-92976 A.

As a technique of performing failure diagnosis for an air conditioning device from a remote place, JP 2007-263442 A discloses a technique using a facility monitoring apparatus that, when a monitoring terminal detects a failure of an air conditioning device, receives data of a failure diagnosis program for the air conditioning device from the monitoring terminal by an e-mail, and executes the received failure diagnosis program.

JP 2004-92976 A discloses a failure diagnosis apparatus that operates a component to be diagnosed of a facility device while the facility device is not working, and performs failure diagnosis for the component based on obtained information.

However, in the conventional techniques, it is difficult to efficiently and rapidly perform failure diagnosis for the air conditioning device. Further improvement is yet to be made.

### SUMMARY OF THE INVENTION

The present disclosure is made to solve the problem described above. An object of the present disclosure is to provide a diagnostic method, a diagnostic apparatus, a diagnostic system each capable of performing efficient and rapid failure diagnosis for a device, and a non-transitory computer readable recording medium storing a diagnostic program capable of performing efficient and rapid failure diagnosis for a device.

A diagnostic method according to an aspect of the present disclosure is a diagnostic method for a diagnostic apparatus that diagnoses a device, the method including receiving log information related to running the device from the device, storing the received log information in a storing unit, obtaining statistical information related to a failure symptom of the device, obtaining a diagnostic element table in which each of a plurality of operating conditions of the device is associated with an element indicating that the failure symptom can be diagnosed, the failure symptom cannot be diagnosed, or the failure symptom can be diagnosed provided that the log information satisfies a predetermined condition, determining, for an element in the diagnostic element table, whether the log information stored in the storing unit satisfies the predetermined condition, the element indicating that the failure symptom can be diagnosed provided that the log information satisfies the predetermined condition, changing, based on a result of the determination, the element in the diagnostic element table to indicate either the failure symptom can be diagnosed or the failure symptom cannot be diagnosed, the element originally indicating that the failure symptom can be diagnosed provided that the log information satisfies the predetermined condition, calculating a diagnostic priority of each of the plurality of operating conditions based on the statistical information and the changed diagnostic element table, and outputting information based on an operating condition, among the plurality of operating conditions, having the diagnostic priority satisfying the predetermined condition.

### BRIEF DESCRIPTION OF THE DRAWINGS

FIG. 1 illustrates a configuration of a diagnostic system according to an embodiment of the present disclosure;

FIG. 2 illustrates a configuration of an air conditioning device according to the embodiment of the present disclosure;

FIG. 3 illustrates an example of log information according to the embodiment of the present disclosure;

FIG. 4 illustrates a configuration of a diagnostic apparatus according to the embodiment of the present disclosure;

FIG. 5 illustrates an example of the log information stored in a log storing unit according to the embodiment of the present disclosure;

FIG. 6 illustrates an example of statistical information according to the embodiment of the present disclosure;

FIG. 7 illustrates an example of a diagnostic element table according to the embodiment of the present disclosure;

FIG. 8 illustrates an example of the diagnostic element table updated by an operating condition checking unit according to the embodiment of the present disclosure;

FIG. 9 is a diagram for explaining a process of calculating a priority using the statistical information illustrated in FIG. 6 and the diagnostic element table illustrated in FIG. 8 according to the embodiment of the present disclosure;

FIG. 10 illustrates calculated priorities of a plurality of operating conditions according to the embodiment of the present disclosure;

FIG. 11 illustrates an example of the priority order table stored in a priority storing unit according to the embodiment of the present disclosure;

FIG. 12 illustrates a configuration of a server according to the embodiment of the present disclosure;

FIG. 13 illustrates an example of statistical information stored in a statistical information storing unit according to the embodiment of the present disclosure;

FIG. 14 is a flowchart for explaining a process of sending log information from an air conditioning device to the diagnostic apparatus according to the embodiment of the present disclosure;

FIG. 15 is a first flowchart for explaining a failure diagnosis process performed by the diagnostic apparatus according to the embodiment of the present disclosure;

FIG. 16 is a second flowchart for explaining the failure diagnosis process performed by the diagnostic apparatus according to the embodiment of the present disclosure;

FIG. 17 illustrates an example of a type input screen to receive an input of type information according to the embodiment of the present disclosure;

FIG. 18 illustrates an example of a diagnosed result screen for providing diagnosed result information to a user according to the embodiment of the present disclosure;

FIG. 19 illustrates an example of the type input screen to receive an input of different type information according to the embodiment of the present disclosure;

FIG. 20 illustrates an example of statistical information associated with different type according to the embodiment of the present disclosure;

FIG. 21 illustrates an example of log information of a different air conditioning device stored in the log storing unit according to the embodiment of the present disclosure;

FIG. 22 illustrates an example of a different diagnostic element table updated by the operating condition checking unit according to the embodiment of the present disclosure;

FIG. 23 is a diagram for explaining a process of calculating the priority using the statistical information illustrated in FIG. 20 and the diagnostic element table illustrated in FIG. 22 according to the embodiment of the present disclosure;

FIG. 24 illustrates calculated priorities of the plurality of operating conditions according to the embodiment of the present disclosure;

FIG. 25 illustrates an example of a different priority order table stored in the priority storing unit according to the embodiment of the present disclosure;

FIG. 26 illustrates an example of a different diagnosed result screen for providing diagnosed result information to a user according to the embodiment of the present disclosure;

FIG. 27 illustrates an example of a symptom input screen for receiving an input of a defect symptom of the air conditioning device reported by an owner of the air conditioning device according to a modification of the embodiment of the present disclosure;

FIG. 28 is a diagram for explaining a process of converting the defect symptom of the air conditioning device into statistical information and calculating the priority using the statistical information obtained by the conversion and the diagnostic element table according to the modification of the embodiment of the present disclosure; and

FIG. 29 illustrates an example of a screen of estimated time to finish diagnosis that displays a time required for finishing the diagnosis according to the modification of the embodiment of the present disclosure.

### DESCRIPTION OF EMBODIMENTS

### Basic Idea of Disclosure

When a defect happens in an air conditioning device (room air conditioner), which is a type of home electronics, a user usually calls a manufacturer of the air conditioning device for repair. To repair the air conditioning device, the manufacturer usually dispatches a mechanic to the user's house. The mechanic specifies a problem causing the defect of the air conditioning device while applying various measuring devices to the air conditioning device. The specified problem is fixed by, for example, replacing a failure component, and the repair is completed.

Use of the Internet of Things (IoT) has recently spread in the air conditioning devices. A user can remotely manipulate the air conditioning device using an information terminal, typified by a smart phone, and remotely check the run condition of the air conditioning device using the information terminal. The IoT can also be used for repair operations. For example, a mechanic may be dispatched to a user's house with an information terminal to transmit a command to run the air conditioning device at an operating condition suitable for diagnosing the air conditioning device or to specify a problem causing the failure using log information collected from the air conditioning device. In such a manner, the problem causing the failure can efficiently be specified in a repair operation.

Techniques to perform failure diagnosis using log information of the air conditioning device are disclosed, for example, in JP 2007-263442 A and JP 2004-92976 A.

In the failure diagnosis for the air conditioning device, the problem causing the failure is specified by diagnosis using log information obtained when the air conditioning device is run at an operating condition. The operating condition is one of a plurality of operating conditions. At which operating condition the air conditioning device is run depends on the problem of the failure to be specified. Which operating condition, among the plurality of operating conditions, is used for the diagnosis is important to perform efficient failure diagnosis.

The techniques disclosed in JP 2007-263442 A and JP 2004-92976 A however do not consider which operating condition is used for diagnosis, among the plurality of operating conditions, and cannot perform efficient failure diagnosis for the air conditioning device. Moreover, to operate the air conditioning device at the plurality of operating conditions one after the other, it will take a long time to perform the failure diagnosis for the air conditioning device.

To solve the problem described above, a diagnostic method according to an aspect of the present disclosure is a diagnostic method for a diagnostic apparatus that diagnoses a device, the method including receiving log information related to running the device from the device, storing the received log information in a storing unit, obtaining statistical information related to a failure symptom of the device, obtaining a diagnostic element table in which each of a plurality of operating conditions of the device is associated with an element indicating that the failure symptom can be diagnosed, the failure symptom cannot be diagnosed, or the failure symptom can be diagnosed provided that the log information satisfies a predetermined condition, determining, for an element in the diagnostic element table, whether the log information stored in the storing unit satisfies the predetermined condition, the element indicating that the failure symptom can be diagnosed provided that the log information satisfies the predetermined condition, changing, based on a result of the determination, the element in the diagnostic element table to indicate either the failure symptom can be diagnosed or the failure symptom cannot be diagnosed, the element originally indicating that the failure symptom can be diagnosed provided that the log information satisfies the predetermined condition, calculating a diagnostic priority of each of the plurality of operating conditions based on the statistical information and the changed diagnostic element table, and outputting information based on an operating condition, among the plurality of operating conditions, having the diagnostic priority satisfying the predetermined condition.

According to the configuration, the operating condition that has the highest probability to specify the failure symptom is preferentially selected among the plurality of operating conditions, and the failure symptom is diagnosed using the log information received after the device has started running at the selected operating condition. Therefore, the failure diagnosis can efficiently and rapidly be performed on the device.

In the diagnostic method, the predetermined condition may be having the highest diagnostic priority.

In the diagnostic method, the output information may be run information to run the device at an operating condition, among the plurality of operating conditions, having the diagnostic priority satisfying the predetermined condition.

In the diagnostic method, the method may further include: diagnosing the failure symptom using the log information received after the device has started running according to the run information.

In the diagnostic method, the output information may be notice information indicating the operating condition, among the plurality of operating conditions, having the diagnostic priority satisfying the predetermined condition.

In the diagnostic method, if the failure symptom is not specified at an operating condition having the highest diagnostic priority, the run information to run the device at an operating condition having the next highest diagnostic priority may be transmitted to the device.

According to the configuration, if the failure symptom is not specified at the operating condition having the highest diagnostic priority, the device is run at the operating condition having the next highest diagnostic priority. The device can be run at different operating conditions until the failure symptom of the device is specified, so that the failure symptom of the device can further surely be specified.

In the diagnostic method, the device may include the air conditioning device and the plurality of operating conditions may include at least a heating operation and a cooling operation of the air conditioning device.

According to the configuration, the operating condition that has the higher probability to specify the failure symptom is preferentially selected among the heating operation and the cooling operation, and the failure symptom is diagnosed using the log information received after the air conditioning device has started running at the selected operating condition. Therefore, the failure diagnosis can efficiently and rapidly be performed on the air conditioning device.

In the diagnostic method, the plurality of operating conditions may include at least a rated operation at which the air conditioning device is operated under a predetermined condition independent of an environment of a space where the air conditioning device is installed and a non-rated operation at which the air conditioning device is operated dependent on the environment of the space.

According to the configuration, the operating condition that has the higher probability to specify the failure symptom is preferentially selected among the rated operation at which the air conditioning device is operated under the predetermined condition independent of the environment of the space where the air conditioning device is installed and the non-rated operation at which the air conditioning device is operated dependent on the environment of the space, and the failure symptom is diagnosed using the log information received after the air conditioning device has started running at the selected operating condition. Therefore, the failure diagnosis can efficiently and rapidly be performed on the air conditioning device.

In the diagnostic method, the statistical information related to a trend of the failure symptom associated with a type of the device may be obtained from the server.

According to the configuration, which obtains the statistical information related to the trend of the failure symptom associated with the type of the device from the server, the statistical information of the server is updated to the latest statistical information, and thereby failure diagnosis for the device can be performed with high accuracy.

In the diagnostic method, the method may further include: receiving an input of the defect symptom of the device reported by an owner of the device, and the statistical information associated with the defect symptom of which input is received may be obtained.

According to the configuration, which receives the input of the defect symptom of the device reported by the owner of the device and obtains the statistical information associated with the defect symptom of which input is received, the failure diagnosis for the device can be performed for the actual defect symptom with further higher accuracy.

In the diagnostic method, the method may further include: calculating an estimated time required for diagnosing the failure symptom of the device based on the diagnostic priority, and outputting the calculated estimated time to the external.

According to the configuration, which calculates the estimated time required for diagnosing the failure symptom of the device based on the diagnostic priority and outputs the calculated estimated time to the external, the mechanic who repairs the device can know the estimated time for diagnosing the failure symptom of the device, so that the failure diagnosis for the device can efficiently be performed.

A diagnostic apparatus according to another aspect of the present disclosure is a diagnostic apparatus for diagnosing a device, the apparatus including a receiving unit configured to receive log information related to running the device from the device, a storing unit configured to store the received log information, a statistical information obtaining unit configured to obtain statistical information related to a failure symptom of the device, a diagnostic element table obtaining unit configured to obtain a diagnostic element table in which each of a plurality of operating conditions of the device is associated with an element indicating that the failure symptom can be diagnosed, the failure symptom cannot be diagnosed, or the failure symptom can be diagnosed provided that the log information satisfies a predetermined condition, a determination unit configured to determine, for an element in the diagnostic element table, whether the log information stored in the storing unit satisfies the predetermined condition, the element indicating that the failure symptom can be diagnosed provided that the log information satisfies the predetermined condition, a change unit configured to change, based on a result of the determination, the element in the diagnostic element table to indicate either the failure symptom can be diagnosed or the failure symptom cannot be diagnosed, the element originally indicating that the failure symptom can be diagnosed provided that the log information satisfies the predetermined condition, a calculating unit configured to calculate a diagnostic priority of each of the plurality of operating conditions based on the statistical information and the changed diagnostic element table, and an output unit configured to output information based on an operating condition, among the plurality of operating conditions, having the diagnostic priority satisfying the predetermined condition.

According to the configuration, the operating condition that has the highest probability to specify the failure symptom is preferentially selected among the plurality of operating conditions, and the failure symptom is diagnosed using the log information received after the device has started running at the selected operating condition. Therefore, the failure diagnosis can efficiently and rapidly be performed on the device.

The diagnostic system according to another aspect of the present disclosure includes the diagnostic apparatus described above, and a device connected to the diagnostic apparatus via a network to communicate with each other, in which the device includes a log generating unit configured to generate log information related to running the device, a transmitting unit configured to transmit the log information to the diagnostic apparatus, a receiving unit configured to receive the run information from the diagnostic apparatus, and a controlling unit configured to control running the device according to the run information.

According to the configuration, the operating condition that has the highest probability to specify the failure symptom is preferentially selected among the plurality of operating conditions, and the failure symptom is diagnosed using the log information received after the device has started running at the selected operating condition. Therefore, the failure diagnosis can efficiently and rapidly be performed on the device.

A non-transitory computer readable recording medium storing a diagnostic program according to another aspect of the present disclosure is a non-transitory computer readable recording medium storing a diagnostic program for diagnosing a device, the diagnostic program for causing a computer to execute: receiving log information related to running the device from the device, storing the received log information in a storing unit, obtaining statistical information related to a failure symptom of the device, obtaining a diagnostic element table in which each of a plurality of operating conditions of the device is associated with an element indicating that the failure symptom can be diagnosed, the failure symptom cannot be diagnosed, or the failure symptom can be diagnosed provided that the log information satisfies a predetermined condition, determining, for an element in the diagnostic element table, whether the log information stored in the storing unit satisfies the predetermined condition, the element indicating that the failure symptom can be diagnosed provided that the log information satisfies the predetermined condition, changing, based on a result of the determination, the element in the diagnostic element table to indicate either the failure symptom can be diagnosed or the failure symptom cannot be diagnosed, the element originally indicating that the failure symptom can be diagnosed provided that the log information satisfies the predetermined condition, calculating a diagnostic priority of each of the plurality of operating conditions based on the statistical information and the changed diagnostic element table, and outputting information based on an operating condition, among the plurality of operating conditions, having the diagnostic priority satisfying the predetermined condition.

According to the configuration, the operating condition that has the highest probability to specify the failure symptom is preferentially selected among the plurality of operating conditions, and the failure symptom is diagnosed using the log information received after the device has started running at the selected operating condition. Therefore, the failure diagnosis can efficiently and rapidly be performed on the device.

Embodiments described below each illustrates an example of the present disclosure. Features of the embodiments, such as values, shapes, components, steps, and orders of the steps are described by means of illustration and not by means of limiting the scope of the present disclosure. Among the components of the embodiments, the components not included in an independent claim that describes the broadest concept is described as an arbitrary component. The contents of the embodiments may be used in combination.

### Embodiments

A diagnostic system according to an embodiment of the present disclosure will be described with reference to the drawings.

The general picture of the diagnostic system according to the embodiment will be described.

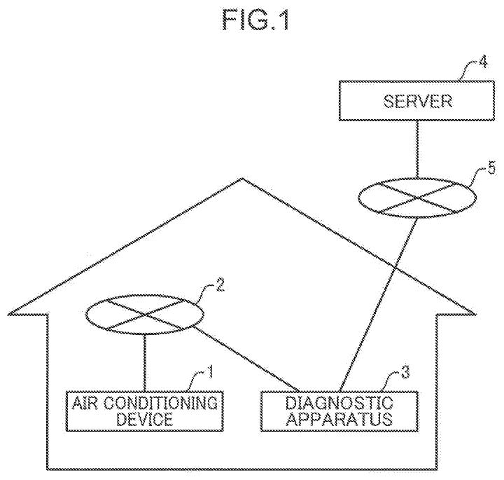

FIG. 1 illustrates a configuration of the diagnostic system according to the embodiment of the present disclosure. As illustrated in FIG. 1, the diagnostic system includes an air conditioning device 1, a diagnostic apparatus 3, and a server 4.

The air conditioning device 1 is connected to the diagnostic apparatus 3 via a first communication path 2 to communicate with each other. The air conditioning device 1 is, for example, a home room air conditioner equipped with the IoT. For example, the first communication path 2 is a wireless local area network (LAN). The air conditioning device 1 is installed in a house of a user. The air conditioning device 1 is an exemplary device to be diagnosed.

The diagnostic apparatus 3 is, for example, a smart phone, a tablet computer, or a personal computer that a mechanic has. The diagnostic apparatus 3 diagnoses the air conditioning device 1.

The server 4 is connected to the diagnostic apparatus 3 via a second communication path 5 to communicate with each other. The second communication path 5 is, for example, a long term evolution (LTE) or a web of the Internet. The server 4 is disposed outside the user's house.

First, a concept of using the embodiment will be described. Next, each of the devices constituting the diagnostic system will be described in detail. The air conditioning device 1 is installed in a house of a typical user. For example, when the user finds an unusual operation of the air conditioning device 1, the user calls a call center of the manufacturer of the air conditioning device 1. On receiving the call, the manufacturer dispatches a mechanic to the user's house. The mechanic goes to the user's house with the diagnostic apparatus 3. The diagnostic apparatus 3 is used together with the server 4 to perform failure diagnosis for the air conditioning device 1. The mechanic properly repairs the air conditioning device 1 based on a result of the diagnosis performed by the diagnostic apparatus 3.

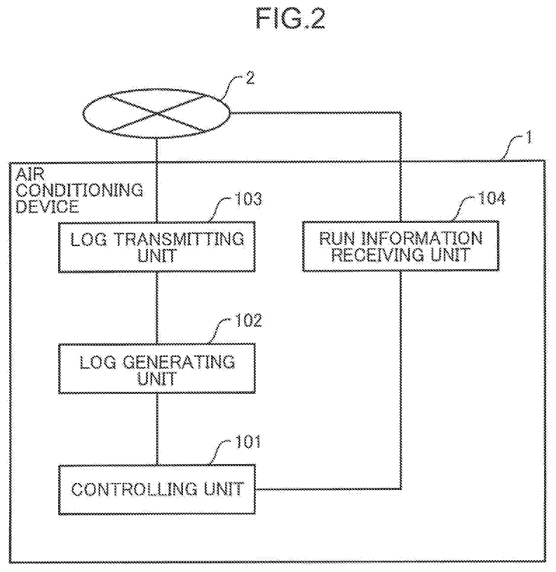

FIG. 2 illustrates a configuration of the air conditioning device according to the embodiment of the present disclosure.

As illustrated in FIG. 2, the air conditioning device 1 includes a controlling unit 101, a log generating unit 102, a log transmitting unit 103, and a run information receiving unit 104.

The controlling unit 101 controls major functions of the air conditioning device 1. The major functions of the air conditioning device 1 are, for example, a cooling function of discharging cool air, a heating function of discharging warm air, dehumidification, a function of turning an indoor-fan, and a function of moving a louver. The controlling unit 101 controls components equipped in the air conditioning device 1, such as a compressor, a fan, and a louver (not shown in FIG. 2), by a manipulation of the user. The controlling unit 101 changes the operation of major functions of the air conditioning device 1 based on the run information received by the run information receiving unit 104. For example, when the controlling unit 101 receives the run information indicating the operating mode of a heating operation with the set temperature of 30° C., the controlling unit 101 causes the air conditioning device 1 to run according to the operating mode and the set temperature indicated by the run information.

The log generating unit 102 generates log information related to running the air conditioning device 1 at a timing when the run condition of the air conditioning device 1 changes. The log information includes, for example, a time stamp, a control signal of a component included in the air conditioning device 1, and a sensed value obtained from a sensor included in the air conditioning device 1.

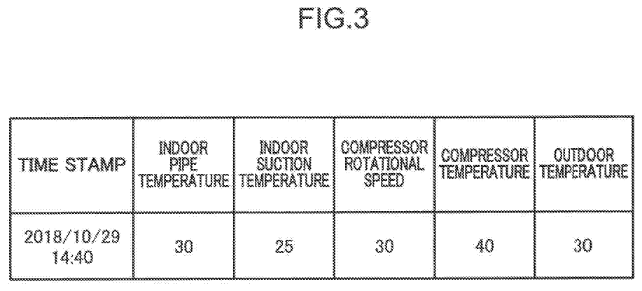

FIG. 3 illustrates an example of the log information according to the embodiment of the present disclosure. As illustrated in FIG. 3, the log information includes, for example, an indoor pipe temperature, an indoor suction temperature, a compressor rotational speed, a compressor temperature, and an outdoor temperature. The log information may include not only these pieces of information but also different pieces of information that can be obtained by the air conditioning device 1. The log generating unit 102 obtains a sensed value from the controlling unit 101 and generates log information including the obtained sensed value. The log generating unit 102 outputs the generated log information to the log transmitting unit 103.

The log generating unit 102 may generate log information regularly at a predetermined time interval, for example, at every 10 minutes.

The log transmitting unit 103 transmits the log information generated by the log generating unit 102 to the diagnostic apparatus 3 via the first communication path 2.

The run information receiving unit 104 receives the run information from the diagnostic apparatus 3 via the first communication path 2. The run information receiving unit 104 outputs the received run information to the controlling unit 101. The run information indicates, for example, that the operating mode is a heating operation with the set temperature of 30° C., and is used to run the air conditioning device 1 at a predetermined operating condition. When the run information receiving unit 104 receives the run information from the diagnostic apparatus 3 via the first communication path 2, the run information receiving unit 104 outputs the run information to the controlling unit 101.

The air conditioning device 1 according to the embodiment is an exemplary device to be diagnosed. The present disclosure is not limited to the air conditioning device 1. The device may be different household appliances such as a washing machine or a refrigerator.

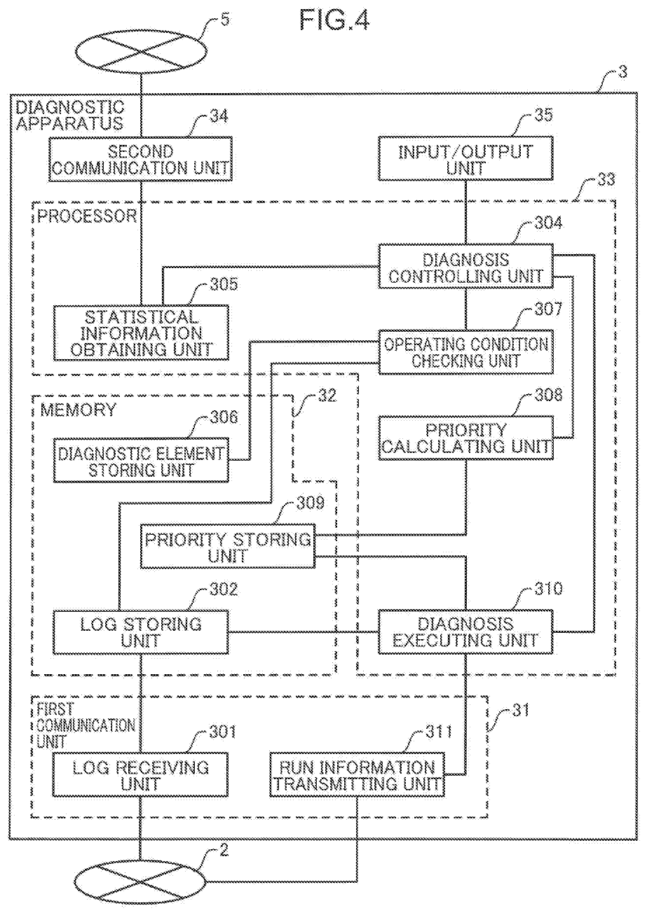

FIG. 4 illustrates a configuration of the diagnostic apparatus according to the embodiment of the present disclosure. The diagnostic apparatus 3 is, for example, a smart phone, a tablet computer, or a personal computer equipped with a touch screen, a microphone, and a camera.

As illustrated in FIG. 4, the diagnostic apparatus 3 includes a first communication unit 31, a memory 32, a processor 33, a second communication unit 34, and an input/output unit 35. The first communication unit 31 includes a log receiving unit 301, and a run information transmitting unit 311. The memory 32 includes a log storing unit 302, a diagnostic element storing unit 306, and a priority storing unit 309. The processor 33 includes a diagnosis controlling unit 304, a statistical information obtaining unit 305, an operating condition checking unit 307, a priority calculating unit 308, and a diagnosis executing unit 310.

The first communication unit 31 receives information from the air conditioning device 1 via the first communication path 2 and transmits the information to the air conditioning device 1.

The log receiving unit 301 receives log information related to running the air conditioning device 1 from the air conditioning device 1 via the first communication path 2. The log information includes, for example, a time stamp, an indoor pipe temperature, an indoor suction temperature, a compressor rotational speed, a compressor temperature, and an outdoor temperature. The log receiving unit 301 stores the received log information in the log storing unit 302.

For example, the memory 32 is a read only memory (ROM) or an electrically erasable programmable read only memory (EEPROM).

The log storing unit 302 stores the log information of the air conditioning device 1 received by the log receiving unit 301.

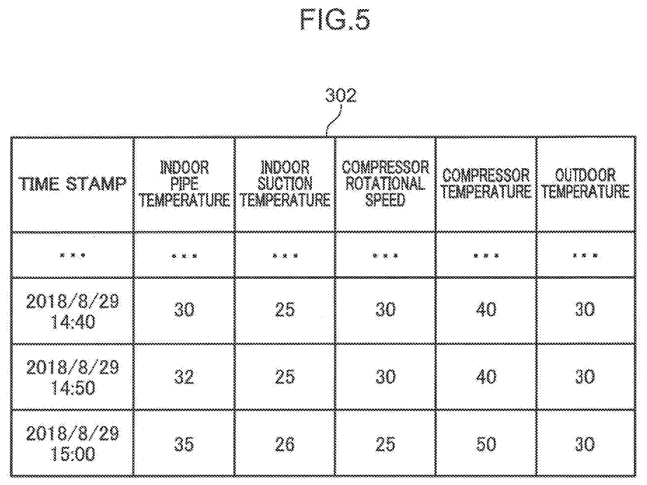

FIG. 5 illustrates an example of log information stored in the log storing unit according to the embodiment of the present disclosure. As illustrated in FIG. 5, the log storing unit 302 stores the log information including the time stamp, the indoor pipe temperature, the indoor suction temperature, the compressor rotational speed, the compressor temperature, and the outdoor temperature in a form of a table.

The second communication unit 34 transmits the information to the server 4 via the second communication path 5 and receives the information from the server 4. The second communication unit 34 receives the statistical information related to the failure symptom of the device from the server 4.

The input/output unit 35 is, for example, a touch panel that receives an input from the user and displays information to be presented to the user. The mechanic who repairs the air conditioning device 1 is the user of the diagnostic apparatus 3. The input/output unit 35 receives type information indicating the type of the air conditioning device 1 by an input from the user.

When the type information is input by the input/output unit 35 from an external (user), the diagnosis controlling unit 304 outputs the input type information to the statistical information obtaining unit 305 and outputs an operating condition check request signal to the operating condition checking unit 307. The type information is, for example, used to identify the type of the air conditioning device 1, for example, “AC1” or “AC2”. The type information specifies the manufactured year and the performance of the type.

When the statistical information is input from the statistical information obtaining unit 305 and the diagnostic element table is input from the operating condition checking unit 307, the diagnosis controlling unit 304 outputs the statistical information and the diagnostic element table to the priority calculating unit 308.

When a priority calculation finish signal is input from the priority calculating unit 308, the diagnosis controlling unit 304 outputs a diagnosis execution start signal to the diagnosis executing unit 310.

When the diagnosed result information is input from the diagnosis executing unit 310, the diagnosis controlling unit 304 causes the input/output unit 35 to display the diagnosed result information. The input/output unit 35 displays the diagnosed result information indicating the diagnosed result of the air conditioning device 1.

The statistical information obtaining unit 305 obtains the statistical information related to the failure symptom of the air conditioning device 1. When type information is input from the diagnosis controlling unit 304, the statistical information obtaining unit 305 transmits the type information to the server 4 via the second communication unit 34 and the second communication path 5. The statistical information obtaining unit 305 obtains the statistical information related to the trend of the failure symptom associated with the type of the air conditioning device 1 from the server 4.

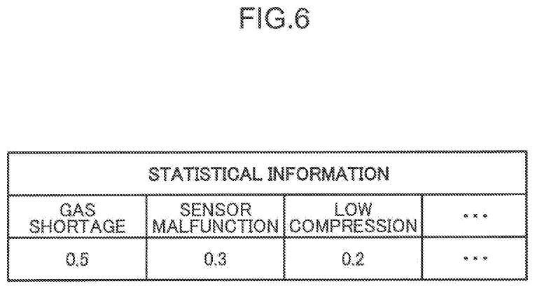

FIG. 6 illustrates an example of the statistical information according to the embodiment of the present disclosure. The statistical information is related to the occurring rate of the failure symptom associated with the type of the air conditioning device 1. The failure symptom of the embodiment includes, for example, gas shortage, sensor malfunction, and low compression. In the example illustrated in FIG. 6, the occurring rate is 0.5 for the gas shortage, 0.3 for the sensor malfunction, and 0.2 for the low compression. The occurring rate is highest for gas shortage and lowest for low compression. The statistical information obtaining unit 305 outputs the statistical information received by the second communication unit 34 to the diagnosis controlling unit 304.

In the example illustrated in FIG. 6, the sum of the occurring rates of all the failure symptoms is 1.0, but not limited to 1.0 in the present disclosure. The sum of the occurring rates of all the failure symptoms may not always be 1.0. Instead of the occurring rate of each of a plurality of failure symptoms, the statistical information may include the occurred number of each of the failure symptoms.

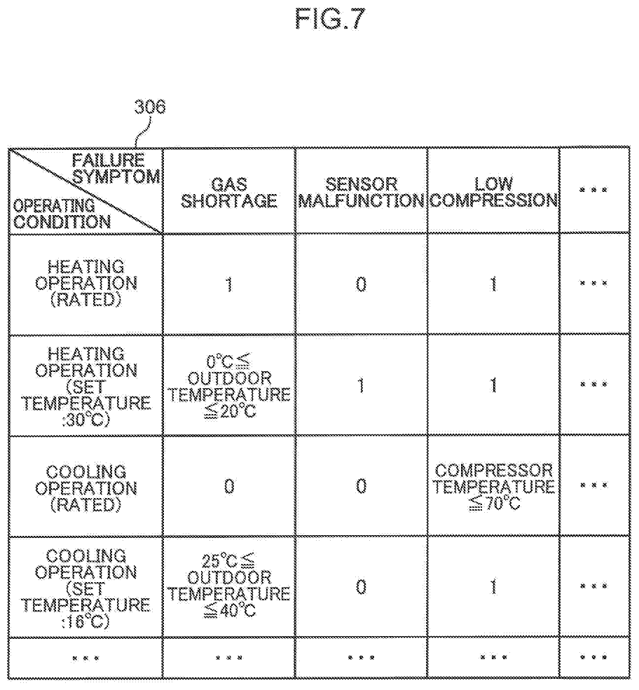

The diagnostic element storing unit 306 stores a diagnostic element table that associates each of a plurality of operating conditions of the air conditioning device 1 with an element indicating that the failure symptom can be diagnosed, the failure symptom cannot be diagnosed, or the failure symptom can be diagnosed provided that the log information satisfies a predetermined condition. The diagnostic element storing unit 306 stores in advance the diagnostic element table as illustrated in FIG. 7.

FIG. 7 illustrates an example of the diagnostic element table according to the embodiment of the present disclosure. Each row of the diagnostic element table shows an operating condition and each column shows a failure symptom. The diagnostic element table indicates which failure symptom can be diagnosed when the air conditioning device 1 is run at a certain operating condition.

The diagnostic element table illustrated in FIG. 7 indicates that, when the air conditioning device 1 is run at a rated heating operation, the gas shortage can be diagnosed, the sensor malfunction cannot be diagnosed, and the low compression can be diagnosed. In FIG. 7, “1” indicates that the failure symptom can be diagnosed and “0” indicates that the failure symptom cannot be diagnosed.

The plurality of operating conditions includes at least a heating operation and a cooling operation of the air conditioning device 1. The plurality of operating conditions includes at least a rated operation at which the air conditioning device 1 is operated under a predetermined condition independent of an environment of a space where the air conditioning device 1 is installed and a non-rated operation at which the air conditioning device 1 is operated dependent on the environment of the space.

The rated operation is an operating mode used for failure diagnosis. Specifically, the rated operation is an operating mode for measuring temperatures and pressures under the same operating condition, where the compressor and the fan are operated at constant rotational speeds regardless of the indoor temperature and the set temperature. To run the air conditioning device 1 at the rated heating operation, the compressor and the fan are operated at constant rotational speeds. To run the air conditioning device 1 at the rated cooling operation, the compressor and the fan are operated at constant rotational speeds.

The non-rated operation is the operating mode typically run by a user. Specifically, the non-rated operation is an operating mode in which the rotational speeds of the compressor and the fan are dynamically changed depending on the indoor temperature and the set temperature to create an optimum air conditioning. In the embodiment, operating modes of running the air conditioning device 1 in the heating operation with the set temperature of 30° C. and in the cooling operation with the set temperature of 16° C. are non-rated operations. When the air conditioning device 1 is run at the heating operation with the set temperature of 30° C., the rotational speeds of the compressor and the fan are dynamically changed to keep the indoor temperature at 30° C. When the air conditioning device 1 is run at the cooling operation with the set temperature of 16° C., the rotational speeds of the compressor and the fan are dynamically changed to keep the indoor temperature at 16° C.

The diagnostic element table illustrated in FIG. 7 indicates that, when the air conditioning device 1 is run at the heating operation with the set temperature of 30° C., the sensor malfunction can be diagnosed as well as the low compression. In the element associated with the operating condition at which the air conditioning device 1 is run at the heating operation with the set temperature of 30° C. and with the failure symptom of gas shortage, a conditional statement of “0° C. outdoor temperature 20° C.” is written. If the log information of the air conditioning device 1 to be diagnosed satisfies the condition, the gas shortage can be diagnosed. If the log information does not satisfy the condition, the gas shortage cannot be diagnosed.

The diagnostic element table illustrated in FIG. 7 indicates that, when the air conditioning device 1 is run at the rated cooling operation, the gas shortage cannot be diagnosed, the sensor malfunction cannot be diagnosed, and the low compression can be diagnosed provided that the log information satisfies a predetermined condition. The predetermined condition is that the compressor temperature is no higher than 70° C.

The diagnostic element table illustrated in FIG. 7 indicates that, when the air conditioning device 1 is run at the cooling operation with the set temperature of 16° C., the gas shortage can be diagnosed provided that the log information satisfies a predetermined condition, the sensor malfunction cannot be diagnosed, and the low compression can be diagnosed. The predetermined condition is that the outdoor temperature is between 25° C. and 40° C., inclusive.

The diagnostic element storing unit 306 may store one diagnostic element table regardless of the type of the air conditioning device 1. The diagnostic element storing unit 306 may store the diagnostic element table for each types of the air conditioning device 1.

The operating condition checking unit 307 obtains the diagnostic element table as illustrated in FIG. 7 from the diagnostic element storing unit 306. The operating condition checking unit 307 determines, for the element in the diagnostic element table, whether the log information stored in the log storing unit 302 satisfies a predetermined condition, the element indicating that the failure symptom can be diagnosed provided that the log information satisfies the predetermined condition. The operating condition checking unit 307 picks out from the diagnostic element table only the element including a conditional statement. The diagnostic element table illustrated in FIG. 7 includes three conditional statements, which are “0° C. ≤outdoor temperature ≤20° C.”, “25° C. ≤outdoor temperature 40° C.”, and “compressor temperature ≤70° C.”. The operating condition checking unit 307 accesses the log storing unit 302 to obtain the log information with the latest time stamp from a plurality of pieces of log information illustrated in FIG. 5. In FIG. 5, the time stamp of “2018/8/29 15:00” is the latest one. From the log information with the latest time stamp, the compressor temperature and the outdoor temperature which are necessary to make determination on the condition are obtained. The compressor temperature is 50° C. and the outdoor temperature is 30° C.

The operating condition checking unit 307 determines whether the obtained log information satisfies the conditions. In the above example, the conditions of “25° C. ≤outdoor temperature ≤40° C.” and “compressor temperature ≤70° C.” are satisfied but the condition of “0° C. ≤outdoor temperature 20° C.” is not satisfied.

Based on a result of the determination, the operating condition checking unit 307 changes the element in the diagnostic element table to indicate either the failure symptom can be diagnosed or cannot be diagnosed, the element originally indicating that the failure symptom can be diagnosed provided that the log information satisfies a predetermined condition. The operating condition checking unit 307 updates the diagnostic element table by changing the element expressing the predetermined condition which the log information satisfies to “1” to indicate the failure symptom can be diagnosed and the element expressing the predetermined condition which the log information does not satisfy to “0” to indicate the failure symptom cannot be diagnosed. The operating condition checking unit 307 outputs the updated diagnostic element table to the diagnosis controlling unit 304.

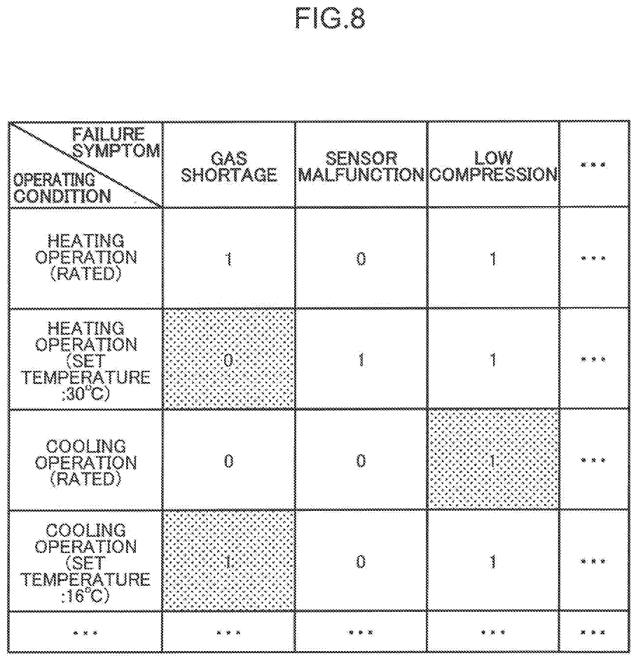

FIG. 8 illustrates an example of the diagnostic element table updated by the operating condition checking unit according to the embodiment of the present disclosure.

In the diagnostic element table illustrated in FIG. 8, the element associated with the operating condition to run the air conditioning device 1 at the heating operation with the set temperature of 30° C. and with the failure symptom of gas shortage is changed to “0”, the element associated with the operating condition to run the air conditioning device 1 at the cooling operation with the set temperature of 16° C. and with the failure symptom of gas shortage is changed to “1”, and the element associated with the operating condition to run the air conditioning device 1 at the rated cooling operation and with the failure symptom of low compression is changed to “1”.

The priority calculating unit 308 calculates diagnostic priorities of the plurality of operating conditions based on the statistical information obtained by the statistical information obtaining unit 305 and the diagnostic element table changed by the operating condition checking unit 307. The statistical information illustrated in FIG. 6 and the updated diagnostic element table illustrated in FIG. 8 are input to the priority calculating unit 308 from the diagnosis controlling unit 304. Then, using the statistical information and the diagnostic element table, the priority calculating unit 308 calculates, for each of the plurality of operating conditions, the probability that the failure of the air conditioning device 1 can be diagnosed when the air conditioning device 1 is run at each operating condition.

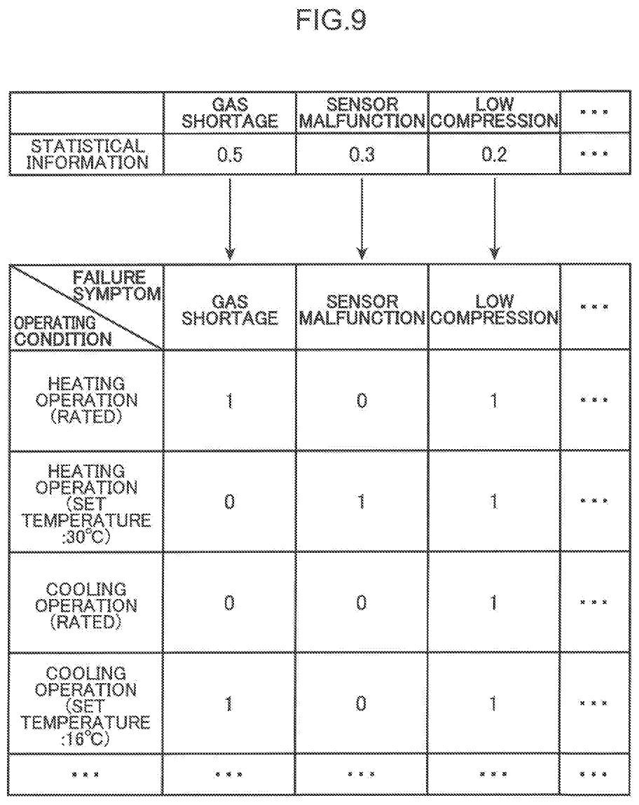

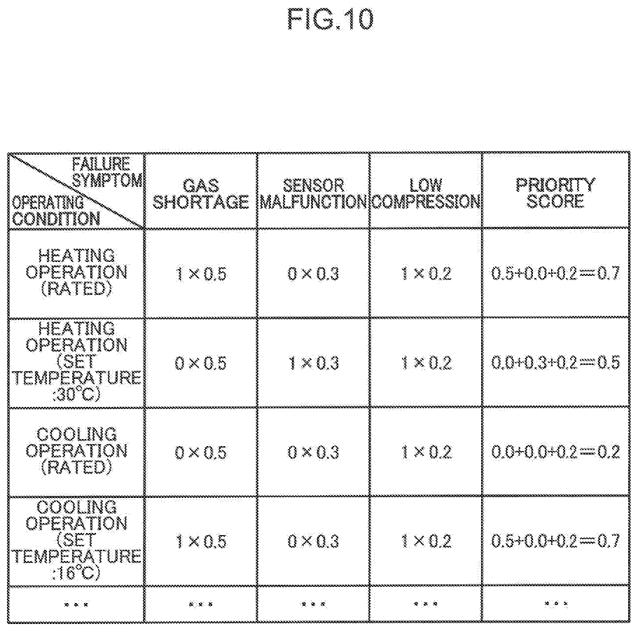

FIG. 9 is a diagram for explaining a process of calculating the priority using the statistical information illustrated in FIG. 6 and the diagnostic element table illustrated in FIG. 8 according to the embodiment of the present disclosure. FIG. 10 illustrates the calculated priorities of the plurality of operating conditions according to the embodiment of the present disclosure.

As illustrated in FIG. 9, the priority calculating unit 308 multiples the value in each element in the diagnostic element table illustrated in FIG. 8 by the occurring rate of each failure symptom in the statistical information illustrated in FIG. 6. For example, the value in each element in the column of the gas shortage in the diagnostic element table is multiplied by 0.5, the value in each element in the column of the sensor malfunction is multiplied by 0.4, and the value in each element in the column of the low compression is multiplied by 0.2. The priority calculating unit 308 sums up the resulting values of the multiplication of the elements for each operating condition, and the calculated total value of each operating condition is the priority score of each operating condition. As illustrated in FIG. 10, for example, the priority score of the operating condition to run the air conditioning device 1 at the rated heating operation is 0.7, the priority score of the operating condition to run the air conditioning device 1 at the heating operation with the set temperature of 30° C. is 0.5, the priority score of the operating condition to run the air conditioning device 1 at the rated cooling operation is 0.2, and the priority score of the operating condition to run the air conditioning device 1 at the cooling operation with the set temperature of 16° C. is 0.7.

The priority calculating unit 308 generates a priority order table in which the plurality of operating conditions is ranked in descending order of the priority score. The priority calculating unit 308 stores the generated priority order table in the priority storing unit 309. The priority calculating unit 308 then outputs a priority calculation finish signal to the diagnosis controlling unit 304.

The priority storing unit 309 stores the priority order table that associates the priority order with the operating condition.

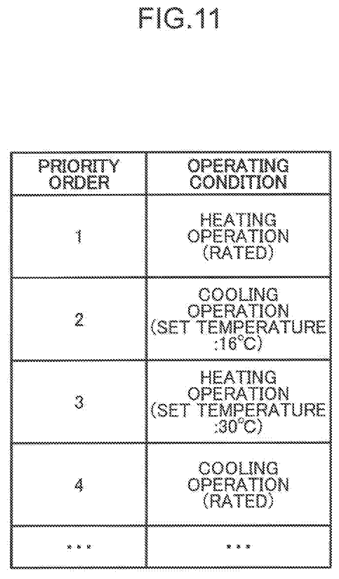

FIG. 11 illustrates an example of the priority order table stored in the priority storing unit according to the embodiment of the present disclosure. As illustrated in FIG. 11, the priority storing unit 309 stores the priority order table in which the plurality of operating conditions is ranked in descending order of the priority score.

For the operating conditions having the same priority score, any operating condition may have a higher priority than other operating conditions. For example, the priority calculating unit 308 may determine the priorities of the plurality of operating conditions having the same priority score at random or give a high priority to the operating condition which is ranked high in the diagnostic element table.

As illustrated in FIG. 11, the operating condition ranked the highest in the priority order is the operating condition to run the air conditioning device 1 at the rated heating operation, the operating condition ranked the second highest in the priority order is the operating condition to run the air conditioning device 1 at the cooling operation with the set temperature of 16° C., the operating condition ranked the third highest in the priority order is the operating condition to run the air conditioning device 1 at the heating operation with the set temperature of 30° C., and the operating condition ranked the fourth highest in the priority order is the operating condition to run the air conditioning device 1 at the rated cooling operation.

When the diagnosis executing unit 310 receives an input of a diagnosis execution start signal from the diagnosis controlling unit 304, the diagnosis executing unit 310 obtains the priority order table illustrated in FIG. 11 from the priority storing unit 309. The diagnosis executing unit 310 obtains the operating conditions from the priority order table in descending order of priority, and transmits the run information via the run information transmitting unit 311 and the first communication path 2 to the air conditioning device 1 to run the air conditioning device 1 at the obtained operating condition. The diagnosis executing unit 310 transmits the run information to the air conditioning device 1 to run the air conditioning device 1 at the operating condition having the highest diagnostic priority among the plurality of operating conditions.

After a predetermined time required for failure diagnosis has elapsed, the diagnosis executing unit 310 obtains log information of the air conditioning device 1 from the log storing unit 302 and performs the failure diagnosis associated with the operating condition of the device to be diagnosed. The diagnosis executing unit 310 diagnose the failure symptom using the log information received after the air conditioning device 1 has started running according to the run information.

The memory 32 stores in advance the time required for failure diagnosis for each of the plurality of operating conditions. After transmitting the run information to the air conditioning device 1, the diagnosis executing unit 310 obtains from the memory 32 the predetermined time required for the failure diagnosis associated with the operating condition of the device to be diagnosed and determines whether the predetermined time required for the failure diagnosis has elapsed.

The diagnosis executing unit 310 diagnoses the failure symptom with the log information using an estimation model generated by machine learning.

Pieces of log information are prepared for the machine learning, that is, a plurality of pieces of log information of the air conditioning device 1 with gas shortage, a plurality of pieces of log information of the air conditioning device 1 with sensor malfunction, a plurality of pieces of log information of the air conditioning device 1 with low compression, and a plurality of pieces of log information of the air conditioning device 1 running normally. Using the prepared pieces of log information of the air conditioning device 1 as data for learning and the failure symptoms associated with the log information as labels, the estimation model is generated using a supervised learning algorithm. The supervised learning algorithm is one of a kind of machine learning techniques and may be, for example, a logistic regression algorithm. The generated estimation model is stored in the memory 32 in advance. When the log information of the air conditioning device 1 is input, the estimation model outputs, for example, a failure symptom among the gas shortage, the sensor malfunction, and the low compression or a normal run as a diagnosed result. The estimation model may be generated for each of the failure symptoms, that is, the gas shortage, the sensor malfunction, the low compression, and the normal run. The estimation model may be generated for each of the plurality of operating conditions.

In the failure diagnosis using the estimation model, the diagnosis executing unit 310 inputs the log information of the air conditioning device 1 to the estimation model and obtains the diagnosed result output from the estimation model, the diagnosed result being any one of the gas shortage, the sensor malfunction, the low compression, and the normal run. The diagnosis executing unit 310 refers to the output from the estimation model to diagnose the failure of the air conditioning device 1 and specify the problem causing the failure of the air conditioning device 1.

If the failure symptom is specified, the diagnosis executing unit 310 outputs the diagnosed result information to the diagnosis controlling unit 304 and finishes the failure diagnosis. On the other hand, if the failure symptom is not specified, the diagnosis executing unit 310 obtains the operating condition having the next highest priority from the priority order table, and transmits the run information via the run information transmitting unit 311 and the first communication path 2 to the air conditioning device 1 to run the air conditioning device 1 at the obtained operating condition. That is, if the failure symptom is not specified for the operating condition having the highest diagnostic priority, the diagnosis executing unit 310 transmits the run information to the air conditioning device 1 to run the air conditioning device 1 at the operating condition having the next highest diagnostic priority. After a predetermined time required for failure diagnosis has elapsed, the diagnosis executing unit 310 obtains the log information of the air conditioning device 1 from the log storing unit 302 and performs the failure diagnosis associated with the operating condition of the device to be diagnosed. The diagnosis executing unit 310 repeats the above process until the failure symptom is specified or the air conditioning device 1 is run at every operating condition in the priority order table.

When the run information is input from the diagnosis executing unit 310, the run information transmitting unit 311 transmits the input run information to the air conditioning device 1 via the first communication path 2.

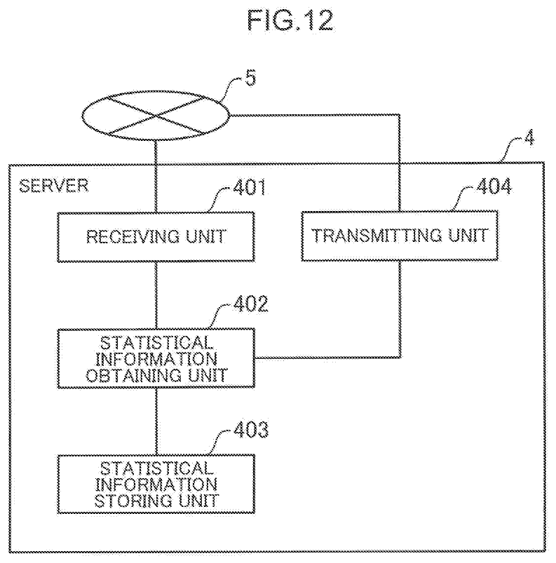

FIG. 12 illustrates a configuration of the server according to the embodiment of the present disclosure.

As illustrated in FIG. 12, the server 4 includes a receiving unit 401, a statistical information obtaining unit 402, a statistical information storing unit 403, and a transmitting unit 404.

The receiving unit 401 receives type information from the diagnostic apparatus 3 via the second communication path 5. The receiving unit 401 outputs the received type information to the statistical information obtaining unit 402.

Based on the input of the type information from the receiving unit 401, the statistical information obtaining unit 402 obtains the statistical information associated with the type information from the statistical information storing unit 403. The statistical information obtaining unit 402 outputs the obtained statistical information to the transmitting unit 404.

For example, the statistical information storing unit 403 includes a ROM or an EEPROM and stores a table that associates the type of the air conditioning device 1 with the statistical information of the failure symptom.

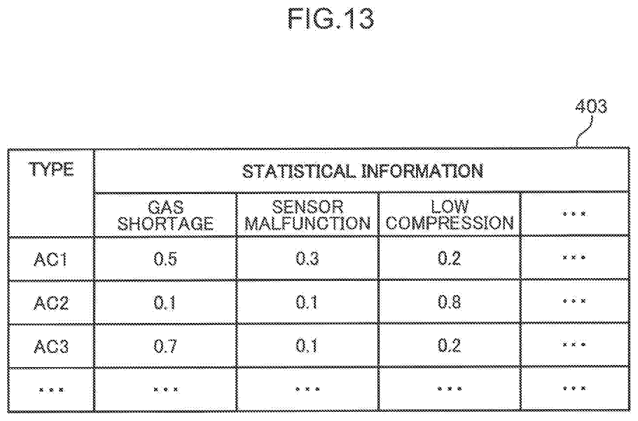

FIG. 13 illustrates an example of the statistical information stored in the statistical information storing unit according to the embodiment of the present disclosure. As illustrated in FIG. 13, the statistical information of the failure symptom is stored for each type. As described above, the statistical information indicates the occurring rate of the failure symptom.

The transmitting unit 404 transmits the statistical information which is input from the statistical information obtaining unit 402 to the diagnostic apparatus 3 via the second communication path 5.

An operation of the diagnostic system according to the embodiment will now be described.

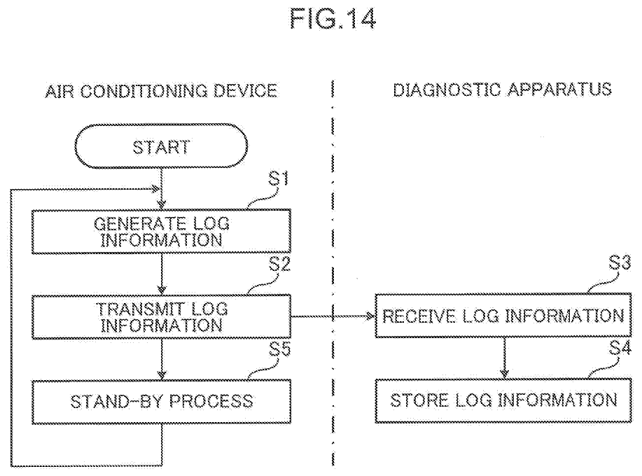

FIG. 14 is a flowchart for explaining the process of sending log information from the air conditioning device to the diagnostic apparatus according to the embodiment of the present disclosure. The process illustrated in FIG. 14 is constantly performed while the air conditioning device 1 and the diagnostic apparatus 3 are connected to each other via the first communication path 2.

First, the log generating unit 102 of the air conditioning device 1 generates the log information related to the run condition of the air conditioning device 1 (step S1).

Next, the log transmitting unit 103 of the air conditioning device 1 transmits the log information generated by the log generating unit 102 to the diagnostic apparatus 3 (step S2).

Next, the log receiving unit 301 of the diagnostic apparatus 3 receives the log information transmitted by the air conditioning device 1 (step S3).

Next, the log receiving unit 301 stores the received log information in the log storing unit 302 (step S4).

Next, the log generating unit 102 of the air conditioning device 1 performs a stand-by process for a predetermined time (step S5). The predetermined time is, for example, 10 minutes. After the predetermined time has elapsed, the process returns to step S1.

The transmitting process of the log information is constantly executed when the power is turned on with a communication path constructed between the air conditioning device 1 and the diagnostic apparatus 3. In such a manner, the log information of the air conditioning device 1 is stored in the log storing unit 302 of the diagnostic apparatus 3. The log generating unit 102 may generate the log information not on a regular basis but at a timing when the control is changed, and transmit the generated log information to the diagnostic apparatus 3.

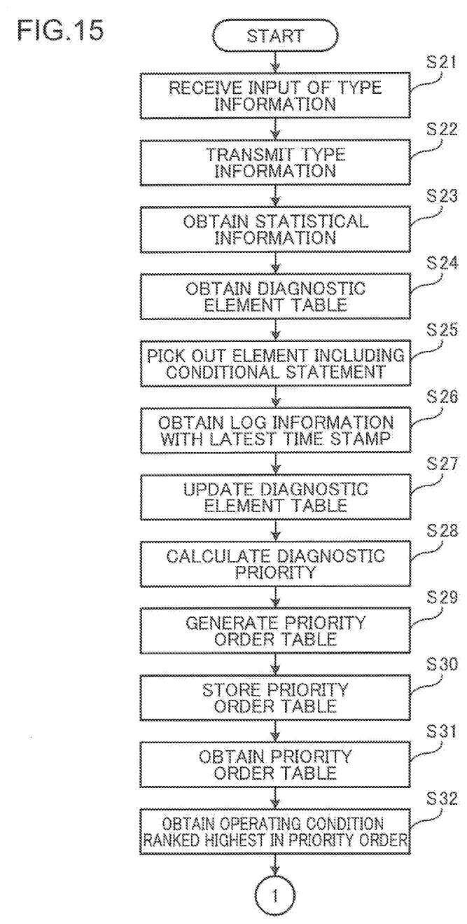

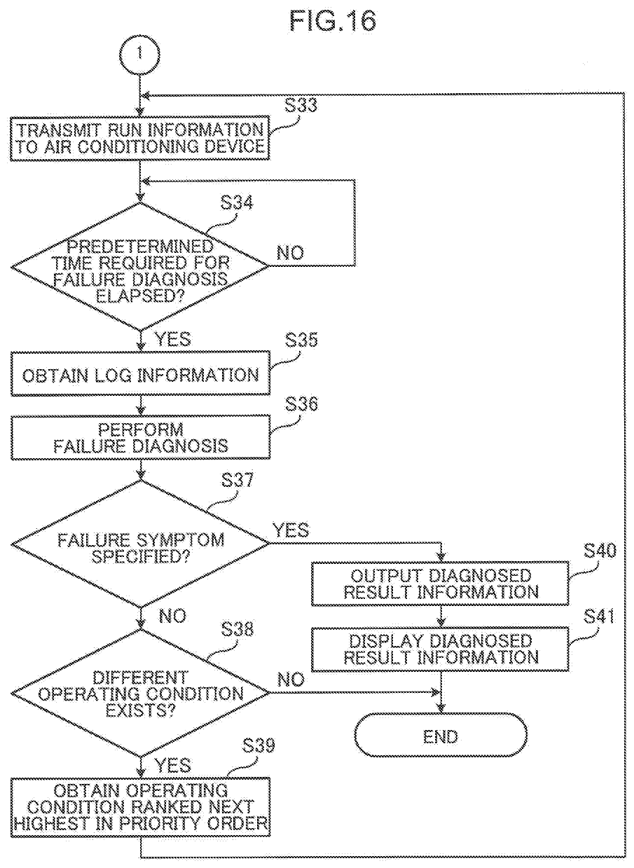

FIG. 15 is a first flowchart for explaining a failure diagnosis process performed by the diagnostic apparatus according to the embodiment of the present disclosure. FIG. 16 is a second flowchart for explaining the failure diagnosis process performed by the diagnostic apparatus according to the embodiment of the present disclosure.

First, the input/output unit 35 receives type information indicating the type of the air conditioning device 1 by an input from the user (step S21). The diagnosis controlling unit 304 instructs the input/output unit 35 to display a type input screen to receive an input of type information given by a user.

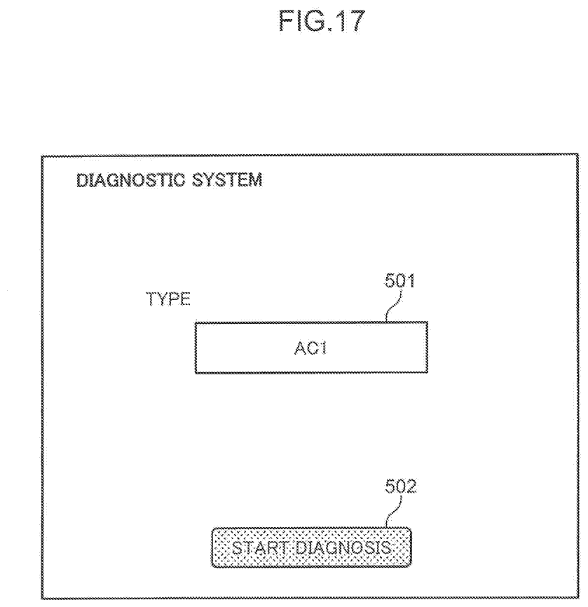

FIG. 17 illustrates an example of the type input screen to receive an input of the type information according to the embodiment of the present disclosure. The input/output unit 35 displays the type input screen illustrated in FIG. 17.

The type input screen illustrated in FIG. 17 includes a type input window 501 to which the type information is input, and a diagnosis start button 502 to instruct the start of diagnosis. The user inputs the type of the air conditioning device 1 to be diagnosed to the type input window 501. The user may directly input the type in the type input window 501 or select the type to be diagnosed among a plurality of candidate types displayed on the type input window 501. The type “AC1” is input in the type input window 501 illustrated in FIG. 17. After inputting the type in the type input window 501, the user pushes the diagnosis start button 502.

When the type information is input through the input/output unit 35, the diagnosis controlling unit 304 outputs the type information to the statistical information obtaining unit 305.

Next, when the type information is input from the diagnosis controlling unit 304, the statistical information obtaining unit 305 transmits the type information to the server 4 via the second communication unit 34 and the second communication path 5 (step S22). When the server 4 receives the type information from the diagnostic apparatus 3, the server 4 obtains the statistical information associated with the type information and transmits the obtained statistical information to the diagnostic apparatus 3. The second communication unit 34 of the diagnostic apparatus 3 receives the statistical information transmitted by the server 4.

Next, the statistical information obtaining unit 305 obtains the statistical information illustrated in FIG. 6 from the server 4 (step S23). The statistical information obtaining unit 305 outputs the obtained statistical information to the diagnosis controlling unit 304. When the statistical information is input, the diagnosis controlling unit 304 outputs the operating condition check request signal to the operating condition checking unit 307.

Next, the operating condition checking unit 307 obtains the diagnostic element table illustrated in FIG. 7 from the diagnostic element storing unit 306 (step S24).

Next, the operating condition checking unit 307 picks out from the obtained diagnostic element table only the element including a conditional statement (step S25).

Next, the operating condition checking unit 307 obtains the log information with the latest time stamp from the log storing unit 302 illustrated in FIG. 5 (step S26).

Next, for the element including a conditional statement, the operating condition checking unit 307 determines whether the latest log information obtained from the log storing unit 302 satisfies the conditional statement, and updates the obtained diagnostic element table based on a result of the determination (step S27). If the latest log information satisfies the conditional statement, the operating condition checking unit 307 changes the element including the conditional statement to “1” to indicate that the failure symptom can be diagnosed. If the latest log information does not satisfy the conditional statement, the operating condition checking unit 307 changes the element including the conditional statement to “0” to indicate that the failure symptom cannot be diagnosed. The operating condition checking unit 307 outputs the updated diagnostic element table illustrated in FIG. 8 to the diagnosis controlling unit 304. The diagnosis controlling unit 304 outputs the statistical information and the diagnostic element table to the priority calculating unit 308. The statistical information illustrated in FIG. 6 and the updated diagnostic element table illustrated in FIG. 8 are input to the priority calculating unit 308 from the diagnosis controlling unit 304.

Next, the priority calculating unit 308 calculates the diagnostic priorities of the plurality of operating conditions based on the statistical information and the diagnostic element table (step S28). Using the statistical information and the diagnostic element table, the priority calculating unit 308 calculates, for each of the plurality of operating conditions, the probability that the failure of the air conditioning device 1 can be diagnosed when the air conditioning device 1 is run at the operating condition. The priority calculating unit 308 multiples the value in each element in the diagnostic element table illustrated in FIG. 8 by the occurring rate of each failure symptom in the statistical information illustrated in FIG. 6 (see FIG. 9). The priority calculating unit 308 sums up the resulting values of the multiplication of the elements for each operating condition, and the calculated total value of each operating condition is the priority score of each operating condition (see FIG. 10).

Next, the priority calculating unit 308 generates a priority order table in which the plurality of operating conditions is ranked in descending order of the priority score (step S29).

Next, the priority calculating unit 308 stores the generated priority order table (see FIG. 11) in the priority storing unit 309 (step S30).

Next, when the diagnosis executing unit 310 receives an input of a diagnosis execution start signal from the diagnosis controlling unit 304, the diagnosis executing unit 310 obtains the priority order table from the priority storing unit 309 (step S31).

Next, the diagnosis executing unit 310 obtains the operating condition ranked the highest in the priority order in the priority order table (step S32).

Next, the diagnosis executing unit 310 transmits the run information via the run information transmitting unit 311 and the first communication path 2 to the air conditioning device 1 to run the air conditioning device 1 at the obtained operating condition (step S33). The air conditioning device 1 receives the run information transmitted by the diagnostic apparatus 3. The air conditioning device 1 controls running of the air conditioning device 1 according to the run information received from the diagnostic apparatus 3.

Next, the diagnosis executing unit 310 determines whether a predetermined time required for the failure diagnosis has passed (step S34). If it is determined that the predetermined time required for failure diagnosis has not yet elapsed (NO in step S34), the diagnosis executing unit 310 executes the determination process of step S34 until the predetermined time required for the failure diagnosis elapses.

If it is determined that the predetermined time required for the failure diagnosis has elapsed (YES in step S34), the diagnosis executing unit 310 obtains the log information of the air conditioning device 1 from the log storing unit 302 (step S35).

Next, the diagnosis executing unit 310 performs the failure diagnosis associated with the operating condition to be diagnosed using the obtained log information (step S36). The diagnosis executing unit 310 performs diagnosis using the log information received after the air conditioning device 1 has started running according to the run information and determines which failure symptom among the plurality of failure symptoms is occurring in the air conditioning device 1 or the air conditioning device 1 is running normally. The diagnosis executing unit 310 inputs the log information to the estimation model and obtains, from the estimation model, an output indicating which failure symptom among the plurality of failure symptoms is occurring in the air conditioning device 1 or the air conditioning device 1 is running normally.

Next, the diagnosis executing unit 310 determines whether the failure symptom is specified (step S37). The diagnosis executing unit 310 may determine that the failure symptom is specified if it is diagnosed that the failure symptom is one of the plurality of failure symptoms or the failure symptom is not specified if it is diagnosed that the air conditioning device 1 is running normally.

The diagnosis executing unit 310 may use the log information received after the air conditioning device 1 has started running according to the run information to calculate the probability of each of the plurality of failure symptoms and the probability of the normal run. The diagnosis executing unit 310 inputs the log information to the estimation model and obtains, from the estimation model, an output indicating the probability of each of the failure symptoms and the probability of the normal run. In this case, the diagnosis executing unit 310 outputs the failure symptom having a probability higher than a predetermined value as a diagnosed result. If there is no failure symptom having a probability higher than the predetermined value, the diagnosis executing unit 310 determines that the failure symptom is not specified. If the probability that the air conditioning device 1 is running normally is higher than the predetermined value, the diagnosis executing unit 310 may determine the failure symptom is not specified.

If the failure symptom is not specified (NO in step S37), the diagnosis executing unit 310 determines whether there exists a different operating condition not yet obtained in the priority order table (step S38). If it is determined that there is no other operating condition not yet obtained in the priority order table (NO in step S38), the process ends. If it is determined that there exists no other operating condition not yet obtained in the priority order table, that is, if the failure symptom is not specified by running the air conditioning device 1 at all of the plurality of operating conditions, the diagnosis executing unit 310 may output the diagnosed result information indicating the failure symptom is not specified to the diagnosis controlling unit 304. The diagnosis controlling unit 304 may cause the input/output unit 35 to display the diagnosed result information indicating the failure symptom is not specified.

If it is determined that there exists a different operating condition not yet obtained in the priority order table (YES in step S38), the diagnosis executing unit 310 obtains the operating condition ranked the second highest in the priority order next to the operating condition obtained the last time from the priority order table (step S39). The process returns to step S33.

If it is determined that the failure symptom is specified (YES in step S37), the diagnosis controlling unit 304 outputs the diagnosed result information indicating the specified failure symptom to the diagnosis controlling unit 304 (step S40).

Next, the diagnosis controlling unit 304 cause the input/output unit 35 to display the diagnosed result information indicating the specified failure symptom (step S41). The input/output unit 35 displays the diagnosed result screen for providing the diagnosed result information to the user.

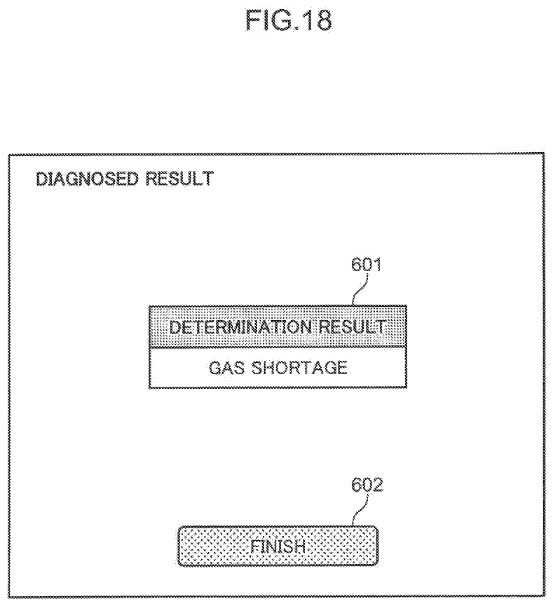

FIG. 18 illustrates an example of the diagnosed result screen for providing the diagnosed result information to the user according to the embodiment of the present disclosure. The input/output unit 35 displays the diagnosed result screen illustrated in FIG. 18.

The diagnosed result screen illustrated in FIG. 18 includes a diagnosed result display area 601 showing the diagnosed result, and an end button 602 to end the diagnosis. The diagnosed result display area 601 illustrated in FIG. 18 shows “gas shortage” as the failure symptom. The user who has checked the diagnosed result pushes the end button 602.

The steps S21 to S30 described above explain the failure diagnosis process in which “AC1” is input as the type information. The failure diagnosis process in which “AC2” is input as the type information will now be described.

First, in step S21, the input/output unit 35 receives type information indicating the type of the air conditioning device 1 by an input from the user.

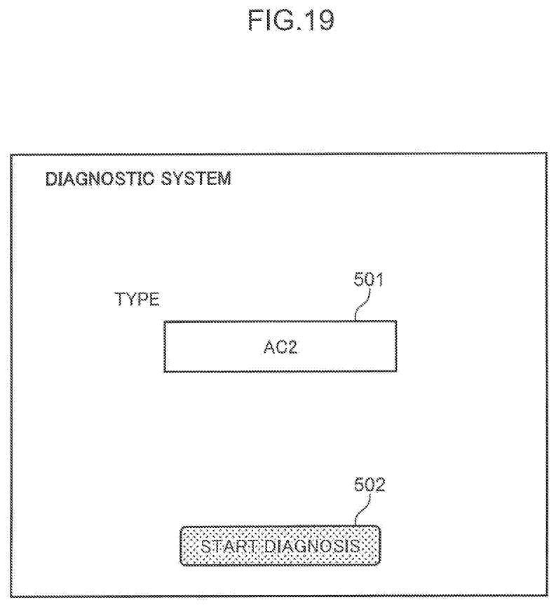

FIG. 19 illustrates an example of the type input screen to receive an input of different type information according to the embodiment of the present disclosure. The input/output unit 35 displays the type input screen illustrated in FIG. 19.

The type input screen illustrated in FIG. 19 includes a type input window 501 to which the type information is input, and a diagnosis start button 502 to instruct the start of diagnosis. The user inputs the type of the air conditioning device 1 to be diagnosed to the type input window 501. The user may directly input the type in the type input window 501 or select the type to be diagnosed among a plurality of candidate types displayed on the type input window 501. The type “AC2” is input in the type input window 501 illustrated in FIG. 19. After inputting the type in the type input window 501, the user pushes the diagnosis start button 502.

Next, when the type information is input through the input/output unit 35, the diagnosis controlling unit 304 outputs the type information to the statistical information obtaining unit 305.

Next, in step S22, when the type information is input from the diagnosis controlling unit 304, the statistical information obtaining unit 305 transmits the type information to the server 4 via the second communication unit 34 and the second communication path 5. The second communication unit 34 of the diagnostic apparatus 3 receives the statistical information transmitted by the server 4.

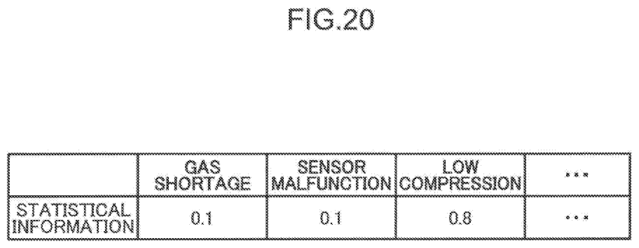

Next, in step S23, the statistical information obtaining unit 305 obtains the statistical information illustrated in FIG. 20 from the server 4.

FIG. 20 illustrates an example of the statistical information associated with a different type according to the embodiment of the present disclosure. In the example illustrated in FIG. 20, the occurring rate is 0.1 for the gas shortage, 0.1 for the sensor malfunction, and 0.8 for the low compression. The occurring rate is highest for the low compression and lowest for the gas shortage and the sensor malfunction. The statistical information obtaining unit 305 outputs the statistical information received by the second communication unit 34 to the diagnosis controlling unit 304. When the statistical information is input, the diagnosis controlling unit 304 outputs the operating condition check request signal to the operating condition checking unit 307.

Next, in step S24, the operating condition checking unit 307 obtains the diagnostic element table illustrated in FIG. 7 from the diagnostic element storing unit 306.

Next, in step S25, the operating condition checking unit 307 picks out from the obtained diagnostic element table only the element including a conditional statement.

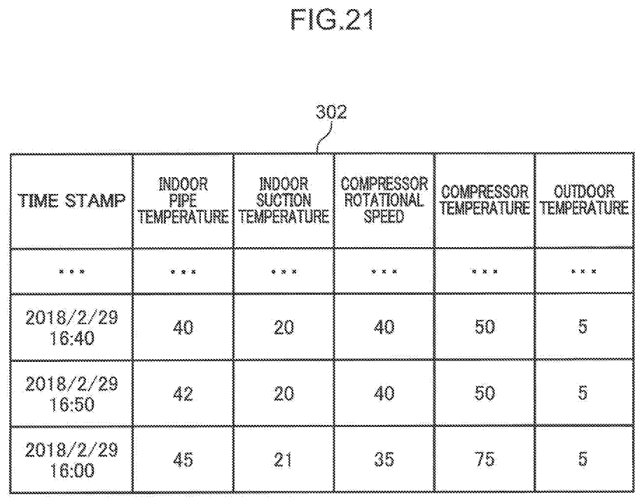

Next, in step S26, the operating condition checking unit 307 obtains the log information with the latest time stamp from the log storing unit 302 illustrated in FIG. 21.

FIG. 21 illustrates an example of the log information of a different air conditioning device stored in the log storing unit according to the embodiment of the present disclosure. As illustrated in FIG. 21, the log storing unit 302 stores the log information including the time stamp, the indoor pipe temperature, the indoor suction temperature, the compressor rotational speed, the compressor temperature, and the outdoor temperature in a form of a table.

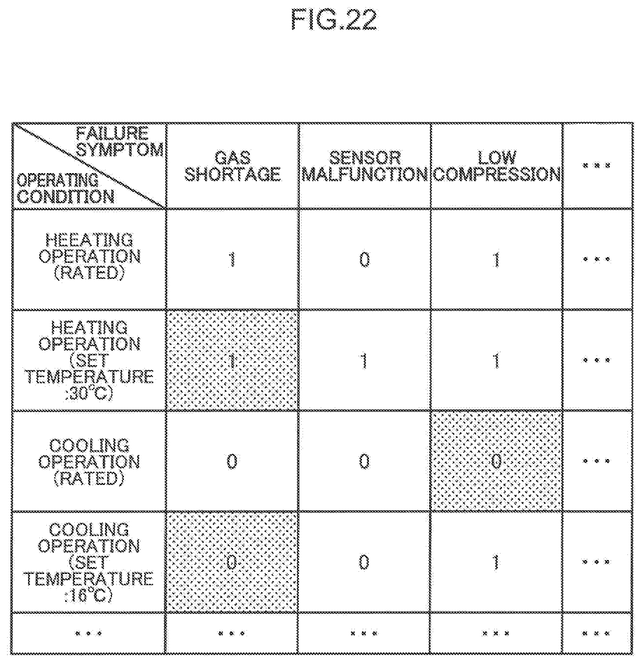

Next, in step S27, for the element including a conditional statement, the operating condition checking unit 307 determines whether the latest log information obtained from the log storing unit 302 satisfies the conditional statement, and updates the obtained diagnostic element table based on a result of the determination. If the latest log information satisfies the conditional statement, the operating condition checking unit 307 changes the element including the conditional statement to “1” to indicate that the failure symptom can be diagnosed. If the latest log information does not satisfy the conditional statement, the operating condition checking unit 307 changes the element including the conditional statement to “0” to indicate that the failure symptom cannot be diagnosed. The operating condition checking unit 307 outputs the updated diagnostic element table illustrated in FIG. 22 to the diagnosis controlling unit 304.

FIG. 22 illustrates an example of a different diagnostic element table updated by the operating condition checking unit according to the embodiment of the present disclosure.

In the diagnostic element table illustrated in FIG. 22, the element associated with the operating condition to run the air conditioning device 1 at the heating operation with the set temperature of 30° C. and with the failure symptom of gas shortage is changed to “1”, the element associated with the operating condition to run the air conditioning device 1 at the cooling operation with the set temperature of 16° C. and with the failure symptom of gas shortage is changed to “0”, and the element associated with the operating condition to run the air conditioning device 1 at the rated cooling operation and with the failure symptom of low compression is changed to “0”.

The diagnosis controlling unit 304 outputs the statistical information and the diagnostic element table to the priority calculating unit 308. The statistical information illustrated in FIG. 20 and the updated diagnostic element table illustrated in FIG. 22 are input to the priority calculating unit 308 from the diagnosis controlling unit 304.

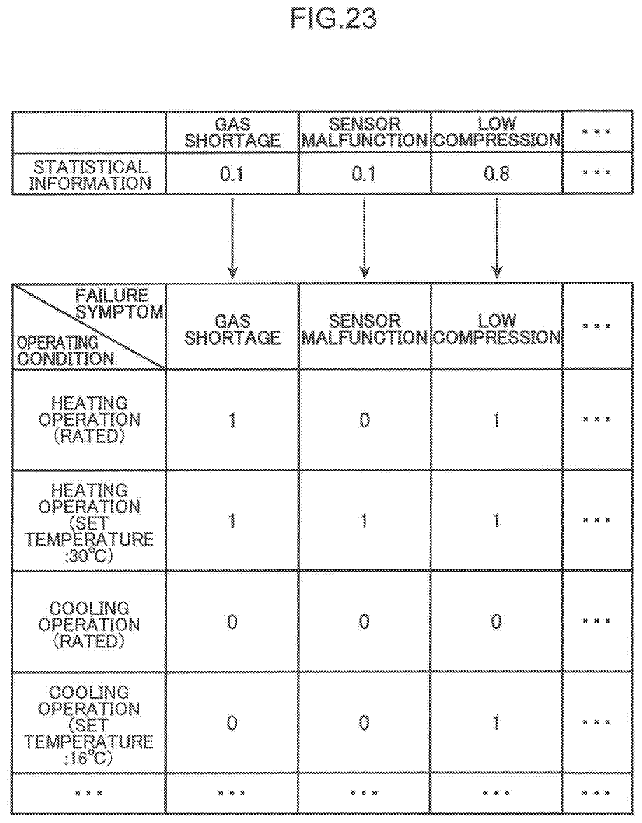

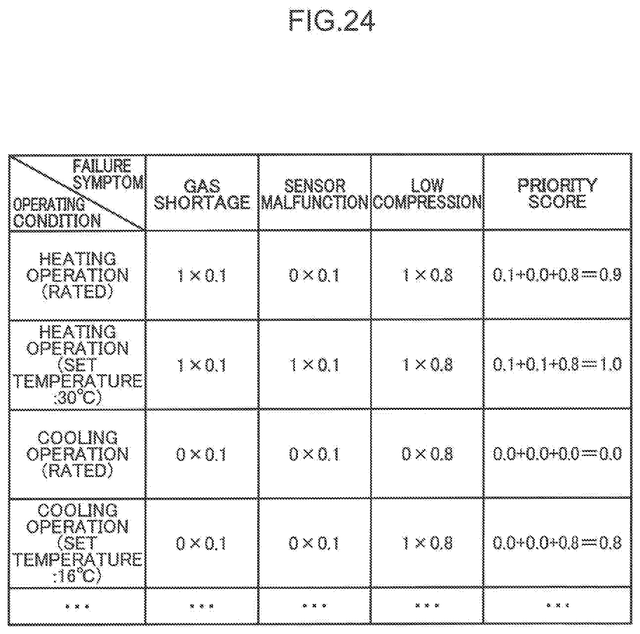

Next, in step S28, the priority calculating unit 308 calculates the diagnostic priorities of the plurality of operating conditions based on the statistical information and the diagnostic element table. Using the statistical information and the diagnostic element table, the priority calculating unit 308 calculates the probability that the failure of the air conditioning device 1 can be diagnosed when the air conditioning device 1 is run at each operating condition. The priority calculating unit 308 multiples the value in each element in the diagnostic element table illustrated in FIG. 8 by the occurring rate of each failure symptom in the statistical information illustrated in FIG. 6 (see FIG. 23). The priority calculating unit 308 sums up the resulting values of the multiplication of the elements for each operating condition, and the calculated total value of each operating condition is the priority score of each operating condition (see FIG. 24).

FIG. 23 is a diagram for explaining a process of calculating the priority using the statistical information illustrated in FIG. 20 and the diagnostic element table illustrated in FIG. 22 according to the embodiment of the present disclosure. FIG. 24 illustrates the calculated priorities of the plurality of operating conditions according to the embodiment of the present disclosure.

As illustrated in FIG. 24, for example, the priority score of the operating condition to run the air conditioning device 1 at the rated heating operation is 0.9, the priority score of the operating condition to run the air conditioning device 1 at the heating operation with the set temperature of 30° C. is 1.0, the priority score of the operating condition to run the air conditioning device 1 at the rated cooling operation is 0.0, and the priority score of the operating condition to run the air conditioning device 1 at the cooling operation with the set temperature of 16° C. is 0.8.

Next, in step S29, the priority calculating unit 308 generates the priority order table in which the plurality of operating conditions is ranked in descending order of the priority score.

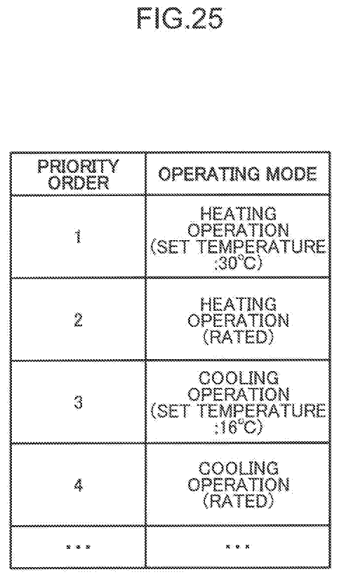

Next, in step S30, the priority calculating unit 308 stores the generated priority order table (see FIG. 25) in the priority storing unit 309.

FIG. 25 illustrates an example of a different priority order table stored in the priority storing unit according to the embodiment of the present disclosure. As illustrated in FIG. 25, the priority storing unit 309 stores the priority order table in which the plurality of operating conditions is ranked in descending order of the priority score.

As illustrated in FIG. 25, the operating condition ranked the highest in the priority order is the operating condition to run the air conditioning device 1 at the heating operation with the set temperature of 30° C., the operating condition ranked the second highest in the priority order is the operating condition to run the air conditioning device 1 at the rated heating operation, the operating condition ranked the third highest in the priority order is the operating condition to run the air conditioning device 1 at the cooling operation with the set temperature of 16° C., and the operating condition ranked the fourth highest in the priority order is the operating condition to run the air conditioning device 1 at the rated cooling operation.

The processes in steps S31 to S41 are executed as described above.

In step S41, the diagnosis controlling unit 304 cause the input/output unit 35 to display the diagnosed result information indicating the specified failure symptom.

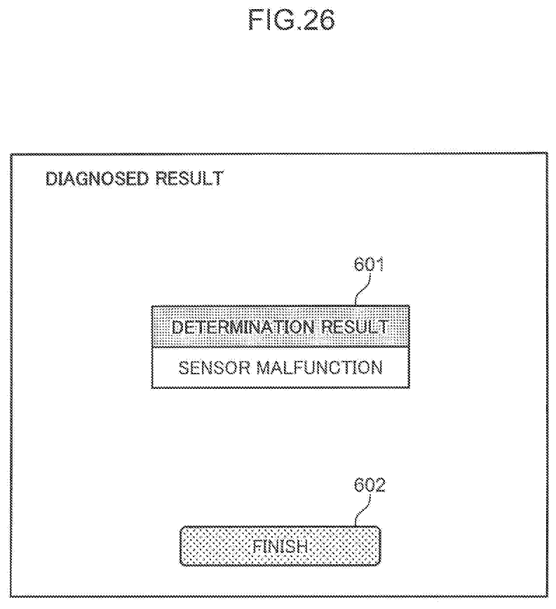

FIG. 26 illustrates an example of a different diagnosed result screen for providing the diagnosed result information to the user according to the embodiment of the present disclosure. The input/output unit 35 displays the diagnosed result screen illustrated in FIG. 26.

The diagnosed result screen illustrated in FIG. 26 includes a diagnosed result display area 601 showing the diagnosed result, and an end button 602 to finish the diagnosis. The diagnosed result display area 601 illustrated in FIG. 26 shows “sensor malfunction” as the failure symptom. The user who has checked the diagnosed result pushes the end button 602.

As described above, the failure of the device can efficiently be diagnosed according to the embodiment.

### Modification

(1) Although the statistical information obtaining unit 305 of the diagnostic apparatus 3 according to the embodiment obtains the statistical information from the server 4, the present disclosure is not limited to such a configuration. For example, the diagnostic apparatus 3 may store the statistical information in advance. In such a manner, the same effect as that of the embodiment can be obtained by a diagnostic system having no server 4.

(2) Although the statistical information obtaining unit 305 of the diagnostic apparatus 3 according to the embodiment obtains from the server 4 the statistical information related to the occurring rates of the failure symptoms for each type, the present disclosure is not limited to such a configuration. For example, the statistical information obtaining unit 305 may convert the defect symptom of the air conditioning device 1 reported by an owner of the air conditioning device 1 into statistical information.

Specifically, the memory 32 stores in advance a table in which the defect symptoms of the air conditioning device 1 are associated with the statistical information indicating the occurring rates of the plurality of failure symptoms. The input/output unit 35 receives an input of the defect symptom of the air conditioning device 1 reported by the owner of the air conditioning device 1. The statistical information obtaining unit 305 obtains the statistical information associates with the defect symptom of which input is received.

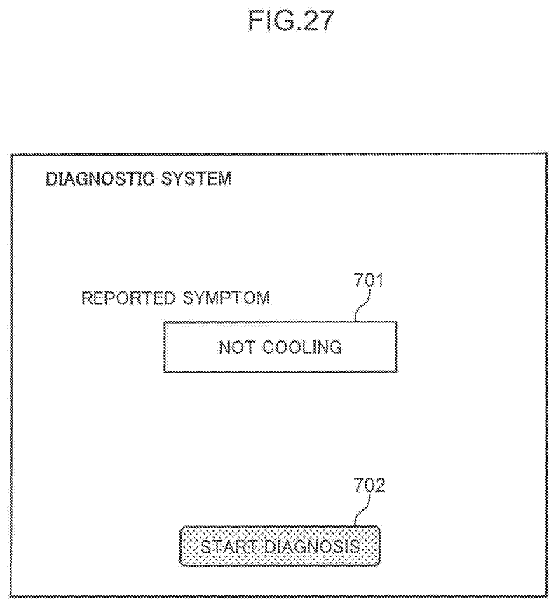

FIG. 27 illustrates an example of a symptom input screen for receiving an input of the defect symptom of the air conditioning device reported by the owner of the air conditioning device according to the modification of the present disclosure. The input/output unit 35 displays the symptom input screen illustrated in FIG. 27.

The symptom input screen illustrated in FIG. 27 includes a symptom input window 701 to which the defect symptom of the air conditioning device 1 reported by the owner of the air conditioning device 1 is input, and a diagnosis start button 702 to start diagnosis. The user inputs the defect symptom of the air conditioning device 1 reported by the owner of the air conditioning device 1 to the symptom input window 701. The user selects, among a plurality of candidate symptoms displayed on the symptom input window 701, the defect symptom of the air conditioning device 1 reported by the owner of the air conditioning device 1. The symptom “not cooling” is input to the symptom input window 701 illustrated in FIG. 27. After inputting the symptom to the symptom input window 701, the user pushes the diagnosis start button 702.

When the symptom is input, the statistical information obtaining unit 305 converts the input symptom into statistical information.

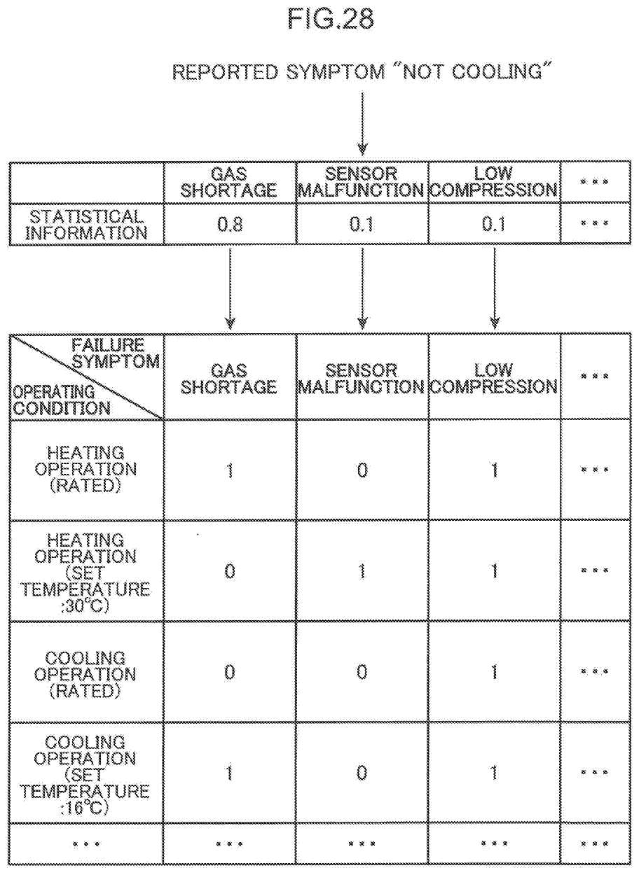

FIG. 28 is a diagram for explaining a process of converting the defect symptoms of the air conditioning device into the statistical information and calculating the priority using the statistical information obtained by the conversion and the diagnostic element table according to the modification of the embodiment of the present disclosure. As illustrated in FIG. 28, the statistical information obtaining unit 305 converts the defect symptom of the air conditioning device 1 into the statistical information. The statistical information obtaining unit 305 picks out the statistical information associated with the defect symptom of the air conditioning device 1 from the table stored in the memory 32. For example, the reported symptom “not cooling” is converted into the statistical information in which the occurring rate is 0.8 for the gas shortage, 0.1 for the sensor malfunction, and 0.1 for the low compression. The priority calculating unit 308 multiples the value in each element in the diagnostic element table by the occurring rate of each failure symptom in the statistical information. The priority calculating unit 308 sums up the resulting values of the multiplication of the elements for each operating condition, and the calculated total value of each operating condition is the priority score of each operating condition. In this manner, an optimum failure diagnosis based on the defect symptom of the air conditioning device 1 reported by the owner of the air conditioning device 1 can be performed.

The memory 32 may store in advance for each type of air conditioning devices 1 a table in which the defect symptoms of the air conditioning device 1 are associated with the statistical information indicating the occurring rates of the plurality of failure symptoms. The input/output unit 35 may receive an input of the type of the air conditioning device 1 and the defect symptom of the air conditioning device 1 reported by the owner of the air conditioning device 1. The statistical information obtaining unit 305 may read a table associated with the input type from the memory 32 and pick out the statistical information associated with the defect symptom of the air conditioning device 1 from the table.

(3) Although the priority score is used for determining the priority order of the plurality of operating conditions in the embodiment, the present disclosure is not limited to such a configuration. The diagnosis controlling unit 304 may calculate an estimated time required for diagnosing the failure symptom of the air conditioning device 1 based on the diagnostic priority calculated by the priority calculating unit 308, and may output the calculated estimated time to the external. For example, the diagnosis controlling unit 304 may calculate the estimated time to finish the diagnosis using the priority score, and display the calculated estimated time to finish the diagnosis. For example, if the priority score is higher than a predetermined value, which means that the probability of specifying the failure symptom is high, the diagnosis controlling unit 304 calculates a short estimated time to finish the diagnosis. If the priority score is no higher than the predetermined value, which means that the probability of specifying the failure symptom is low, the diagnosis controlling unit 304 calculates a long estimated time to finish the diagnosis.

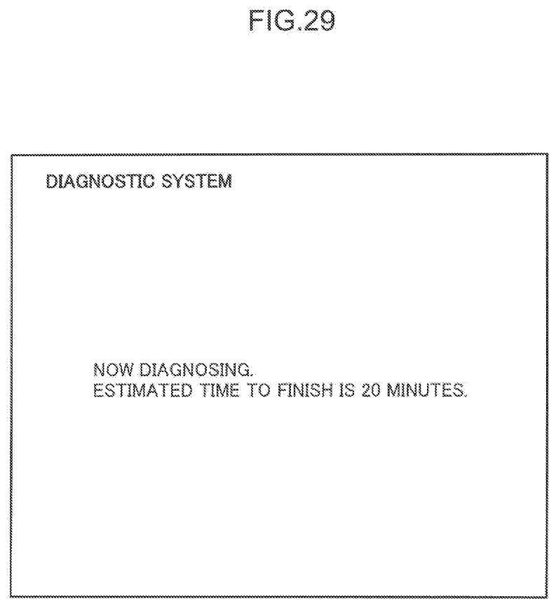

FIG. 29 illustrates an example of the screen of estimated time to finish diagnosis that displays the time required for finishing the diagnosis according to the modification of the embodiment of the present disclosure. The diagnosis controlling unit 304 calculates an estimated time to finish the diagnosis according to the diagnostic priority calculated by the priority calculating unit 308, and causes the input/output unit 35 to display the calculated estimated time to finish the diagnosis. The input/output unit 35 displays the screen of estimated time to finish diagnosis illustrated in FIG. 29. This provides useful information to the mechanic who does diagnosis.

The diagnosis controlling unit 304 may calculate the time required for running all of the plurality of operating conditions. In this case, the diagnosis controlling unit 304 may calculate the estimated time to finish the diagnosis by multiplying the priority score of each of the plurality of operating conditions by a predetermined time and summing up the resulting values of the multiplication.

The diagnosis controlling unit 304 may calculate the time required for running the air conditioning device 1 at the operating condition having the highest priority and cause the input/output unit 35 to display only the calculated time. The diagnosis controlling unit 304 may calculate a first time required for running the air conditioning device 1 at the operating condition having the highest priority and a second time required for running the air conditioning device 1 at all of the plurality of operating conditions, and cause the input/output unit 35 to display the first time together with the second time.

(4) Although the operating condition checking unit 307 according to the embodiment determines whether the latest log information satisfies the predetermined condition, the present disclosure is not limited to such a configuration. For example, when the latest compressor temperature of the air conditioning device 1 is 72° C., the log information does not satisfies the condition that the compressor temperature is no higher than 70° C. in the diagnostic element table illustrated in FIG. 7, so that the operating condition checking unit 307 determines that the failure symptom of low compression cannot be diagnosed. Since the compressor temperature gradually drops in course of time while the air conditioning device 1 is not running, the compressor temperature may become 70° C. or lower after 5 minutes has elapsed.

Therefore, when the operating condition checking unit 307 determines that the latest log information does not satisfies the predetermined condition, the operating condition checking unit 307 may calculate the time it takes until the latest log information satisfies the predetermined condition, and cause the input/output unit 35 to display the calculated time. The input/output unit 35 may display the time it takes until the latest log information satisfies the predetermined condition, and do a countdown until the remaining time becomes zero. For example, the memory 32 may store in advance the time it takes until the compressor temperature drops by 1° C. When the latest compressor temperature is 72° C. and if the failure symptom can be diagnosed provided that the compressor temperature becomes 70° C. or lower, the operating condition checking unit 307 may calculate the time it takes until the compressor temperature drops by 2° C., and cause the input/output unit 35 to display the calculated time. In such a manner, the failure diagnosis having further higher accuracy can be performed.

When the difference between the latest log information (compressor temperature) and the threshold of the conditional statement (70° C.) is no higher than a predetermined value, the operating condition checking unit 307 may calculate the time it takes until the latest log information satisfies the predetermined condition.

(5) The modifications (1) to (4) may be combined.

Although each components of the embodiment is a dedicated piece of hardware, the function of the component may be realized by executing a software program suitable for each component. The function of each component may be realized by reading and executing a software program stored in a recording medium, such as a hard disk or a semiconductor memory, by a program executing unit, such as a central processing unit (CPU) or a processor.

A part or all of the functions of the device according to the embodiment of the present disclosure is typically realized as a large scale integration (LSI), which is an integrated circuit. These may each be provided as a single chip or a portion or all of them may be included in a single chip. The integrated circuit is not limited to an LSI but may be realized by a dedicated circuit or a general-purpose processor. A field programmable gate way array (FPGA), which is an LSI programmable after having been manufactured, or a reconfigurable processor in which a connection or setting of a circuit cell inside the LSI is reconfigurable may be used.

A portion or all of the functions of the device according to the embodiment of the present disclosure may be realized by executing a program by a processor, such as a CPU.

Values used above are all exemplarily presented to specifically explain the present disclosure, so that the present disclosure is not limited by the exemplary values.

The order of executing the steps shown in the flowchart is an example for specifically explaining the present disclosure. As long as the same effect is obtained, the steps may be executed in an order other than the order described above. A portion of the step may be executed at the same time as the execution of (in parallel with) a different step.

The diagnostic method, the diagnostic apparatus, the diagnostic system, and the non-transitory computer readable recording medium storing the diagnostic program according to the present disclosure can efficiently and rapidly perform failure diagnosis for the device, and thus are useful for diagnosing the device.

This application is based on Japanese Patent application No. 2019-000567 filed in Japan Patent Office on Jan. 7, 2019 the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A diagnostic method for a diagnostic apparatus that diagnoses a device, the method comprising:
receiving log information related to running the device from the device;
storing the received log information in a storing unit;
obtaining statistical information related to a failure symptom of the device;
obtaining a diagnostic element table in which each of a plurality of operating conditions of the device is associated with an element indicating that the failure symptom can be diagnosed, the failure symptom cannot be diagnosed, or the failure symptom can be diagnosed provided that the log information satisfies a predetermined condition;
determining, for an element in the diagnostic element table, whether the log information stored in the storing unit satisfies the predetermined condition, the element indicating that the failure symptom can be diagnosed provided that the log information satisfies the predetermined condition;
changing, based on a result of the determination, the element in the diagnostic element table to indicate either the failure symptom can be diagnosed or the failure symptom cannot be diagnosed, the element originally indicating that the failure symptom can be diagnosed provided that the log information satisfies the predetermined condition;
calculating a diagnostic priority of each of the plurality of operating conditions based on the statistical information and the changed diagnostic element table; and
outputting information based on an operating condition, among the plurality of operating conditions, having the diagnostic priority satisfying the predetermined condition.

2. The diagnostic method according to claim 1, wherein the predetermined condition is having a highest diagnostic priority.

3. The diagnostic method according to claim 1, wherein the output information is run information to run the device at an operating condition, among the plurality of operating conditions, having the diagnostic priority satisfying the predetermined condition.

4. The diagnostic method according to claim 3, further comprising diagnosing the failure symptom using log information received after the device has started running according to the run information.

5. The diagnostic method according to claim 1, wherein the output information is notice information indicating an operating condition, among the plurality of operating conditions, having the diagnostic priority satisfying the predetermined condition.

6. The diagnostic method according to claim 1, wherein if the failure symptom is not specified at an operating condition having the highest diagnostic priority, the run information to run the device at an operating condition having the next highest diagnostic priority is transmitted to the device.

7. The diagnostic method according to claim 1, wherein
the device includes an air conditioning device, and
the plurality of operating conditions includes at least a heating operation and a cooling operation of the air conditioning device.

8. The diagnostic method according to claim 7, wherein the plurality of operating conditions includes at least a rated operation in which the air conditioning device is operated under a predetermined condition independent of an environment of a space where the air conditioning device is installed and a non-rated operation in which the air conditioning device is operated dependent on the environment of the space.

9. The diagnostic method according to claim 1, wherein the statistical information related to a trend of the failure symptom associated with a type of the device is obtained from a server.

10. The diagnostic method according to claim 1,
further comprising receiving an input of a defect symptom of the device reported by an owner of the device, and
wherein the statistical information associated with the defect symptom of which input is received is obtained.

11. The diagnostic method according to claim 1, further comprising
calculating an estimated time required for diagnosing the failure symptom of the device based on the diagnostic priority, and
outputting the calculated estimated time to an external.

12. A diagnostic apparatus for diagnosing a device, the apparatus comprising:
a receiving unit configured to receive log information related to running the device from the device;
a storing unit configured to store the received log information;
a statistical information obtaining unit configured to obtain statistical information related to a failure symptom of the device;
a diagnostic element table obtaining unit configured to obtain a diagnostic element table in which each of a plurality of operating conditions of the device is associated with an element indicating that the failure symptom can be diagnosed, the failure symptom cannot be diagnosed, or the failure symptom can be diagnosed provided that the log information satisfies a predetermined condition;
a determination unit configured to determine, for an element in the diagnostic element table, whether the log information stored in the storing unit satisfies the predetermined condition, the element indicating that the failure symptom can be diagnosed provided that the log information satisfies the predetermined condition;
a change unit configured to change, based on a result of the determination, the element in the diagnostic element table to indicate either the failure symptom can be diagnosed or the failure symptom cannot be diagnosed, the element originally indicating that the failure symptom can be diagnosed provided that the log information satisfies the predetermined condition;
a calculating unit configured to calculate a diagnostic priority of each of the plurality of operating conditions based on the statistical information and the changed diagnostic element table; and
an output unit configured to output information based on an operating condition, among the plurality of operating conditions, having the diagnostic priority satisfying the predetermined condition.

13. A diagnostic system comprising:
the diagnostic apparatus according to claims 12, and
a device connected to the diagnostic apparatus via a network to communicate with each other, wherein
the device includes
a log generating unit configured to generate log information related to running the device,
a transmitting unit configured to transmit the log information to the diagnostic apparatus,
a receiving unit configured to receive the run information from the diagnostic apparatus, and
a controlling unit configured to control running the device according to the run information.

14. A non-transitory computer readable recording medium storing a diagnostic program for diagnosing a device, the diagnostic program for causing a computer to execute:
receiving log information related to running the device from the device,
storing the received log information in a storing unit,
obtaining statistical information related to a failure symptom of the device,
obtaining a diagnostic element table in which each of a plurality of operating conditions of the device is associated with an element indicating that the failure symptom can be diagnosed, the failure symptom cannot be diagnosed, or the failure symptom can be diagnosed provided that the log information satisfies a predetermined condition,
determining, for an element in the diagnostic element table, whether the log information stored in the storing unit satisfies the predetermined condition, the element indicating that the failure symptom can be diagnosed provided that the log information satisfies the predetermined condition,
changing, based on a result of the determination, the element in the diagnostic element table to indicate either the failure symptom can be diagnosed or the failure symptom cannot be diagnosed, the element originally indicating that the failure symptom can be diagnosed provided that the log information satisfies the predetermined condition,
calculating a diagnostic priority of each of the plurality of operating conditions based on the statistical information and the changed diagnostic element table, and
outputting information based on an operating condition, among the plurality of operating conditions, having the diagnostic priority satisfying the predetermined condition.
